(19) United States
(12) Patent Application Publication
(10) Pub. No.: US 2026/0184613 A1
(43) Pub. Date: Jul. 2, 2026

(54) SYSTEM AND METHOD FOR ADDITION AND DISSOLUTION OF MINERALS TO PROVIDE A REDUCTION IN CARBON DIOXIDE EMISSIONS AND OTHER BENEFITS

(71) Applicants: Hampton Roads Sanitation District, Virginia Beach, VA (US); D.C. WATER AND SEWER AUTHORITY, WASHINGTON, DC (US)

(72) Inventors: RILEY DOYLE, Virginia Beach, VA (US); ALEXANDRIA GAGNON, Virginia Beach, VA (US); MATT POE, Virginia Beach, VA (US); BERNHARD WETT, Innsbruck (AT); SUDHIR MURTHY, Virginia Beach, VA (US); HAYDEE DE CLIPPELEIR, Alexandria, VA (US); CHARLES BOTT, Virginia Beach, VA (US)

(21) Appl. No.: 19/439,131

(22) Filed: Jan. 2, 2026

Related U.S. Application Data
(60) Provisional application No. 63/741,269, filed on Jan. 2, 2025.

(51) Int. Cl. C02F 3/12; C02F 11/02; C02F 101/10

(52) U.S. Cl. CPC C02F 3/1226; C02F 3/1215; C02F 11/02; C02F 2101/105

(57) ABSTRACT

Systems and methods for wastewater treatment or biological culturing to manage the dissolution and/or the relative proportions of dissolved or particulate minerals using physical and/or chemical sequestration and addifeed, including the dissolution of additives such as calcium carbonate (CaCO₃) in wastewater treatment for reduction in CO₂ emissions from treatment plants. The system and methods include culturing or treating water or wastewater to manage the dissolution and/or the relative proportions of dissolved or particulate minerals, including calcium carbonate (CaCO₃).

### CROSS-REFERENCE TO RELATED APPLICATION

This application is entitled to and hereby claims priority under 35 U.S.C. § 119(e) to U.S. Provisional Patent Application No. 63/741,269, filed Jan. 2, 2025, which is hereby incorporated herein in its entirety.

### FIELD OF THE DISCLOSURE

This disclosure relates generally to a method, a system, and an apparatus for wastewater treatment or biological culturing and, more specifically, to a method, a system, and an apparatus for wastewater treatment or biological culturing with addition of an addifeed to supply inorganic carbon, or to improve alkalinity or dispensation of alkalinity or alkaline solutions, including through pH improvement, with sequestration of minerals for the improvement in such mineral dissolution, and for the sequestration of carbon dioxide such as through the use of minerals, including carbonates, waste oxides or hydroxides, or through the system, process and apparatus of such sequestration including to improve reaction rates or reaction stoichiometry of microorganisms.

### BACKGROUND OF THE DISCLOSURE

A problem with dispensation of minerals (such as calcium carbonate) in neutral or near neutral solutions is their poor dissolution in such solutions. This poor dissolution depends on the size of mineral particles, the larger particles dissolving more slowly than smaller particles. Larger grain sizes however tend to be easier and cheaper to manufacture and transport and procure as they are more easily available. The instant disclosure addresses this problem and others, including dispensation of dissolved alkalinity or inorganic carbon from such minerals, for example, within a reactor or in a chemical source or mix tank (such as a slurry tank) to thereby improve stoichiometry of substances or to increase reaction rates of substances or organisms.

Gravity or membrane separators can be utilized to remove or recycle solids from an activated sludge process or a biological culturing process. In addition to such separators, gravimetric (using gravity for classification), density, or size classifiers can help classify solids based on their density or size and enable the classification of solids with superior settling, flux, or fouling mitigation characteristics. There are also selectors that can effectively out-select or deselect organisms or morphologies such as filamentous or flocculant bacteria and promote the growth of granules, resulting in denser sludge (i.e. densification). Since denser or larger sludge settles more quickly, separators such as clarifiers can be included to accommodate higher loading rates. As a result, higher mixed liquor concentrations can be tolerated in a biological treatment process and higher influent loads can be treated within an existing footprint.

U.S. Pat. No. 9,242,882, entitled “Method and Apparatus for Wastewater Treatment Using Gravimetric Selection,” describes a method and a system for selecting and retaining activated sludge solids (biological organisms) with superior settling characteristics using gravimetric selection. U.S. Pat. No. 9,242,882 is hereby incorporated herein in its entirety, as if fully set forth herein.

Since polyphosphate-accumulating organisms (PAOs) are naturally dense due to their polyphosphate granules, external gravimetric selectors can be used to select and retain PAOs, thereby enhancing biological phosphorus removal. The growth and retainment of granules can promote environments with varying redox conditions within a single particle. A single particle may have an aerobic exterior, anoxic interior, and anaerobic core. This environment can achieve simultaneous nitrogen and phosphorus removal in an aerated reactor. This summarizes a background approach for selection of organisms or biological morphologies using gravimetric selectors.

U.S. Pat. No. 9,670,083, entitled “Method and Apparatus for Wastewater Treatment Using External Selection,” describes a method and an apparatus for biological wastewater treatment that includes a biological selector and a physical selector for improving sludge settling characteristics. In various embodiments, the apparatus includes an internal biological reactor where wastewater and recycled biomass are combined to provide a high substrate and high electron acceptor gradient for generating morphological biomass features that favor granule formation over floc and filament formation. The granules improve densification and settling of biological solids. A physical selector, such as, for example, an external gravimetric or external screen selector, can be operated on the biomass waste stream to collect and retain densified or larger, respectively, biomass aggregates. The physical selector includes dense granule selection and is configured for wasting lighter filaments and flocs. U.S. Pat. No. 9,670,083 is hereby incorporated herein in its entirety, as if fully set forth herein.

U.S. Pat. No. 11,999,641, entitled “Method and Apparatus for Multi-Deselection in Wastewater Treatment,” describes various embodiments of systems and methods relating to, among other things, physical selection, deselection or outselection for smaller, less dense, sheared or compress biological solids in sludge. The patent describes an embodiment of a system that includes a first deselection step occurring at a reactor or at a clarification step, which can include separately deselecting for such biological solids, and a second deselection step occurring in an external selector. Compared to state-of-the art solutions, the double deselection promotes more efficient removal of slow settling biological solids, while simultaneously allowing the maintenance of multiple solids residence times for fast and slow growing organisms. Deselection can occur in a clarifier, such as at the periphery of the tank or at the surface of a blanket, using a positive or negative pressure device. Structures such as slotted or perforated plates, pipes or manifolds can be included to assist in such deselection. Baffles can also be included for such deselection. U.S. Pat. No. 11,999,641 is hereby incorporated herein in its entirety, as if fully set forth herein.

### SUMMARY OF THE DISCLOSURE

The inventors have discovered a need for 1) improved nitrification and biological phosphorous removal, or rates that are dependent on autotropic organisms or rates that decrease with a decrease in pH (such as in anaerobic or aerobic digestion), and 2) a continued need to improve settling or dewatering solids properties in wastewater treatment systems. The inventors have further discovered that methodologies equipped with either or both chemical sequestrators and physical sequestrators (including gravimetric sequestrators), and methodologies to manage the dissolution of minerals by sequestering or retaining such minerals, can help improve these rates or solids properties. These rates or solids properties can be increased through the management of supply and sequestration of minerals that increase the pH or improve the supply of inorganic carbon or through the management of mineral particulates, while simultaneously sequestering carbon. This sequestration includes a physical or chemical sequestrator that achieves a solid-phase sequestration of minerals to further accommodate a gas phase sequestration of carbon dioxide. This solid-phase sequestration of minerals improves liquid-phase dissolution of minerals for the gas-phase sequestration of carbon dioxide. A limitation associated with this supply of minerals (including and not limited to calcium carbonate) can be the management of this dissolution. Helping manage this dissolution and/or the maintenance of relative proportions of dissolved and particulate minerals, while simultaneously managing rates or solids properties using a sequestrator apparatus or an overall sequestration system and method is an aspect of the claimed invention.

According to an aspect of the disclosure, iron or aluminum salts/chemicals can be included for chemical phosphorus removal, deep aeration tanks, or pure oxygen aeration tanks to decrease and maintain lower pH levels of reactors. This lower pH level or reduction in pH level can be counter to the proper functioning of reactors, including autotrophic processes such as aerobic nitrification or anaerobic ammonium oxidation. Caustic (sodium hydroxide) chemicals or lime can be added, however the addition of such can be prohibitively expensive in such pH management. The present disclosure provides a novel method, system, and apparatus for wastewater treatment or biological culturing to manage the dissolution and/or the relative proportions of dissolved or particulate minerals using physical and/or chemical sequestration of minerals and gases and supplying addifeed. Along with the benefits provided above, the dissolution of minerals such as, for example, calcium carbonate (CaCO₃) wastewater treatment provides for reduction in CO₂ emissions from treatment plants.

According to an aspect of the disclosure, a system is provided for culturing or treating water or wastewater to manage the dissolution and/or the relative proportions of dissolved or particulate minerals, including addifeeds. The system comprises: an influent input that is configured to receive an influent from a first source; an additive input configured to receive an addifeed in a solid, liquid or slurry form from a second source that could be in the form of a tank, reactor, pipe, or a container of any shape or size; a processor (such as a bioreactor) having an input configured to receive and supply the influent and either a pre-dissolved or dissolvable addifeed to a treatment or culturing process in the processor, and having an output configured to output a biomass containing solids and undissolved addifeed; a physical sequestrator configured to select solids including the undissolved addifeed from the biomass, output non-selected (deselected) biological solids that contains a minimum of undissolved or non-sequestered minerals at a first output as a waste stream, retain the selected solids and the sequestrated undissolved carbonate (CaCO₃) or undissolved equivalent calcium carbonate as CaCO₃, and output the sequestrated undissolved carbonate (CaCO₃) or undissolved equivalent calcium carbonate as CaCO₃ as a recycle stream at a second output, wherein the recycle stream is returned to the processor and added to the culturing or treatment process. The sequestration of such undissolved minerals provides additional time and reactivity for the minerals to dissolve, as well as to improve and manage their dissolution for subsequent sequestration of gaseous carbon dioxide.

In various embodiments, the second source can be configured to receive carbon dioxide from the processor or from other sources within a wastewater treatment system, including and not limited by CO₂ produced by other treatment processes such as, for example, digesters or anaerobic tanks. In some embodiments, the second source can be configured to receive carbon dioxide from sources such as, for example, blowers, mixers, pumps, engines or generators, or from other parts or processes in sewer or industrial sources that would not have been captured were not for the presence of such second source (also called a pre-sequestrator) for pre-dissolution and/or acidification (also called pre-acidification) of minerals or calcium carbonate to enhance or manage this dissolution ahead of this processor.

In some embodiments, one or more sequestrators and/or pre-sequestrators are included to manage the dissolution or pre-dissolution and/or the relative input or processing of dissolved or particulate minerals, including addifeeds, to enhance biological rates, such as nitrification or biological phosphorus uptake or mixed liquor settling properties. The concomitant sequestration of carbon dioxide is one of many benefits of including one or more sequestrators and/or pre-sequestrators.

The system can further include at least one solid-liquid separator having an input and at least two outputs. The solid-liquid separator can be configured to receive from the output of the processor the biomass, separate a portion of the solids and undissolved calcium carbonate (CaCO₃) from the biomass, output an effluent at one of the at least two outputs, and output the portion of the solids and undissolved calcium carbonate (CaCO₃) at another of the at least two outputs. The another of the at least two outputs of the solid-liquid separator can be connected to the input of the physical sequestrator.

The system can include one or more covers for any or all tanks and sources. The covers can help manage gases and the dissolution of such gases in the system, including gases produced in the processor or added to or received from external sources. The cover is itself a sequestrator (or internal sequestrator) or can be configured to optimize the performance of either or both of the sequestrator or pre-sequestrator by selectively covering or sealing or partly sealing parts of the system. The use of covers can allow for pressurized (either positive or negative/vacuum) systems for the processor or sources. The covers improve dissolution of the addifeed (such as CaCO₃) for the purpose of such sequestration of carbon dioxide by the addifeed.

The system can include deep tanks (deep or tall tanks ranging from 25-35 feet or greater) for any and all tanks or processors for water and wastewater treatment. The deep tanks can help manage gases and improve the dissolution of such gases in the system, included gases (such as carbon dioxide) produced in the processor or added to or received from external sources, to improve the solubility of the addifeed. The deep tank is itself a sequestrator (or internal sequestrator) for the improved dissolution of the addifeed by accommodating the gas dissolution, lowering of pH, or the improved solubility of minerals. In combination with other sequestrators or pre-sequestrators, the deep tank can help optimize their performance. In the case of pure oxygen aeration tanks or deep aeration tanks (equal to or more than 25-35 feet), the autotrophic processes can be limited by low pH values (such as pH<6), which can be caused by carbon-dioxide (CO₂) supersaturation, and the addition of sufficient alkalinity can be prohibitively expensive. The use of addifeed and associated sequestrators (internal or external) or pre-sequestrators optimizes the overall sequestration of minerals and gaseous carbon dioxide while simultaneously promoting autotrophic reactions and improvements to solids properties.

The system can include a gas purifier for gas purification, such as, for example, a digester or a sewer gas purification. The gas purifier, which can partly or wholly be included in, or as, a pre-sequestrator, can be configured to remove carbon dioxide and other gaseous pollutants (including hydrogen sulfide), for any or all tanks or processors for water and wastewater treatment. In some embodiments the gas is removed to: acidify and improve dissolution of a mineral source (addifeed) sent to the processor such as by using a slurry tank; control alkalinity by providing a source of alkalinity; control concentrations of inorganic carbon by providing a source of inorganic carbon; or improve rates or solids properties by controlling provisioning particulates for improving and optimizing rates or solids properties. The concomitant sequestration of such carbon dioxide while achieving such purification is one of numerous benefits of the instant disclosure.

The slurry tank can be solid or liquid or a combination of solid and liquid with the purpose of dispensation of addifeed. This tank can optionally be a pre-sequestrator by receiving carbon dioxide from any source to pre-acidify and improve dissolution of addifeed. This improved dissolution can benefit the aforementioned biological rates as well as solids properties. The slurry tank can be completely mixed, plug flow, a combination of complete mix and plug flow, reactors in series, or of any format. It could be stratified if needed, it could have a decant, or supernate for the supply of addifeed or pre-dissolved addifeed.

In some embodiments, addifeed particles may be purposefully added to provide cores (i.e. ballast or growth mediums) to promote the formation of biological aggregates encapsulating the seeded particles. The particles may be added as various materials including and not limited to the minerals being sequestered, for example, in a bioreactor, to initiate or seed the formation of a granule, that could then be separated by, or integrated with, for example, either an external gravimetric or an external screen sequestrator. Further, organisms may be selected for include but not limited to nitrification, anaerobic ammonium oxidation, biological phosphorus removal, denitrifying methane oxidizers, biological sulfur or sulfide oxidation, or methanogenesis. The use and maintenance of ballasts or growth mediums for improving reaction rates of such organisms or the solids properties of morphologies hosting such organisms is a feature of this invention.

In various embodiments, addifeed particles can be added to the system or process to provide cores for microbial aggregation, which in aerobic or anaerobic granular sludge encapsulate the addifeed particles and form biomass granules or densified flocs. The center (or core) of such biomass-aggregates will have lower redox-potential due to limited diffusion of oxygen and nitrate, thereby favoring reductive, hydrolyzing and fermentative biological processes that lead to a tentative reduction in the pH-value, which can be buffered by the encapsulated particles, such as, for example, CaCO₃ particles included in the addifeed. This way the retention of biomass-aggregates with encapsulated addifeed particles can contribute to, or be utilized to control, dissolution-management and dissolution-performance. The cores can additionally sequester gaseous carbon dioxide produced by these biomass-aggregates as they are in the immediate vicinity, as an embodiment of employing this sequestrator and addifeed approach. The addifeed cores can also manage the pH conditions in the vicinity of the biomass-aggregates and improve reactivity that are dependent on such pH conditions.

In various embodiments, the solid-liquid separator can include one or more of a settling tank, a lamella clarifier, a filter, a dissolved air floatation or a membrane; and the physical sequestrator can include one or more of a cyclone (hydrocyclone), a screen, a filter, a centrifuge, a lamella clarifier, a settling column, an internal stratification source, a baffle, a pump or flow source, a mixer or mixing source, or a gas outlet or a gas source. The solid-liquid separator can include at least two outputs, including an underflow output. The physical sequestrator can include any of a density sequestrator, a size sequestrator, a shear sequestrator, or a compressibility sequestrator.

The pre-sequestrator can include a tank or other containment structure having a shape and size suitable for the system and to improve or optimize the dissolution or pre-dissolution of minerals in the system based on or using carbon dioxide.

The dissolution of minerals in the pre-sequestrator can be achieved, in some embodiments, through the ingress of carbon dioxide, including:
Direct Injection under Pressure: CO₂ gas is injected or otherwise forced into a confined space or medium in the system at a pressure higher than atmospheric pressure.
Chill the Solution: Since the rate at which CO₂ dissolves in a liquid increases inversely with the temperature of the liquid, the liquid can be cooled to increase dissolution. A salt solution can be chilled to a predetermined temperature, optimally between 4-8° C. (39-46° F.), before injection of CO₂. Additionally, the solubility of mineral calcium carbonate can be increased at this temperature, since mineral calcium carbonate is more soluble at lower temperatures.
Apply High Pressure or Maintain Pressure: The system can include a carbonator configured to force and infuse CO₂ gas into the solution under pressure (for example, greater than atmospheric pressure). In an embodiment, the carbonator can include a commercial carbonator suitable for wastewater treatment. The container holding the infused solution can be sealed to maintain the pressure and keep the CO₂ dissolved in the solution.
Agitation/Mixing: The system can include one or more mixers to shake and/or stir the solution to thereby increase the surface area of contact between the gas and liquid and increase the rate and amount of the CO₂ dissolved in the solution.
Time: The system can be configured to control the amount of time (that is, the contact time) the solution is maintained under pressure to facilitate infusion, dissolvement, or dispersion of the CO₂ into the solution until equilibrium is reached. The longer the contact time under pressure, the more CO₂ will dissolve until equilibrium is reached.
   Once dispersed a portion of the dissolved CO₂ can react with water or slurry to form carbonic acid and/or react with an addifeed (for example, CaCO₃ or its equivalent) to form bicarbonate and calcium ions that can serve as a source of alkalinity or inorganic carbon for process enhancement. The calcium (or alkaline earth metal) ion can promote improved solids properties, including settling, thickening, and dewatering. A mixture that includes the dissolved CO₂, carbonic acid, bicarbonate ions, and/or calcium ions can then be sent to the processor. The pre-sequestrator can include one or more of a clarifier, lamella, a settling tank, a cyclone, a hydrocyclone, a centrifuge, a gravity settling device, a classifier, a screen or other constructed or mechanical (such as a mixer or baffle) or hydraulic (such as a gas flow or sparge device or pump) sequestration device in addition to or in lieu of the slurry tank, or other device that facilitates sequestration of particles from a mixture based on density or gravity or size, to manage such pre-sequestration of minerals relative to its managed dissolution with such CO₂.

In some embodiments, the system includes a pre-sequestrator without an external or internal sequestrator, and/or an external or internal sequestrator without a pre-sequestrator—that is, the apparatus in those systems is configured to be functional with either or both being optional. The pre-sequestrator can include a chemical pre-sequestrator or a chemical sequestrator. The sequestrator can include a physical sequestrator or a physical pre-sequestrator such as using a stratification, decant, classifier, pump or mixing source within a slurry tank. In various embodiments, the concurrent operation of one or more pre-sequestrators and/or sequestrator within the system, in a unified manner, can provide significant synergistic results, including, for example, enhanced addifeed dissolution and alkalinity supply, which gives process improvements and CO₂ removal. The benefit can also include (one or more of) but not limited to improvements to solids morphology, a ballast for sedimentation (solid-liquid separation), a ballast for improved classification of light and heavy solids fractions, improvement to membrane flux and/or reduced membrane fouling where the membrane is used for solid-liquid separation, and improvement to biological rates.

The physical sequestrator can include at least two outputs, including a first output to select and return an addifeed as CaCO₃, and a second output to desequester and waste a minimum of the addifeed. The physical sequestrator can be configured such that a wastage ratio between the first and second outputs (waste:select) of the addifeed is between 0 percent and 50 percent. The physical sequestrator can be an internal or external sequestrator. An internal sequestrator is internal to the processor. An external sequestrator (such as a hydrocyclone or screen or centrifuge or external lamella or external classifier) is external to the processor.

In various embodiments the system can include a return line connected to the processor. The second output of the physical sequestrator can be connected to the return line, or one or more outputs of the physical sequestrator can be wholly or partly connected to the return line, and the return line can supply the recycle stream to the processor. In some embodiments, the system can include a waste return sequestrator, such as, for example, a valve or a pump, to selectively return waste to the reactor.

In various embodiments the system can include a physical sequestrator that is connected directly to the processor where part or all of the second output is returned and part or all of the first output is wasted, and wherein the second output contains a majority of an addifeed. In some embodiments, the addifeed is supplied at an input located upstream of the processor and/or connected to the recycle stream or in a sludge line upstream of the recycle stream.

The physical sequestrator can be configured to provide or increase the dissolution time for the undissolved addifeed (for example, CaCO₃ or an equivalent) to dissolve and to reduce the calcium carbonate wastage ratio.

The dissolution time can have a time period during which nearly all undissolved addifeed (for example, CaCO₃ or an equivalent) is dissolved in the treatment process. The dissolution time can include a contact time (discussed above).

The physical sequestrator can be configured to retain the addifeed (for example, CaCO₃ or an equivalent) to provide continuous dissolution of calcium carbonate or its equivalent in the system.

The physical sequestrator can be configured to retain undissolved addifeed (for example, CaCO₃ or an equivalent) and minimize loss to a waste activated sludge line or where the addifeed (for example, CaCO₃ or its equivalent) wastage ratio (waste:retained) is between 0 percent and 50 percent, or where the reduction in the addifeed is more than 5 percent.

The pre-sequestrator can include at least two outputs, including a first output to select and return/retain an addifeed as CaCO₃, and a second output to desequester and waste a minimum of the addifeed. The pre-sequestrator can be configured such that a wastage ratio between the first and second outputs (waste:select) of the addifeed is between 0 percent and 50 percent.

The pre-sequestrator can be designed in a manner that the performance criteria are similar to a physical sequestrator.

An amount of dissolvable addifeed (for example, CaCO₃ or an equivalent) can be added to increase alkalinity in the treatment process up to a maximum of where carbon dioxide (CO₂) volatilization is driven to less than 50% of the baseline CO₂ emissions.

An amount of dissolvable addifeed (for example, CaCO₃ or an equivalent) can be added to increase alkalinity in the treatment process up to a maximum of where carbon dioxide (CO₂) volatilization is driven to less than 10% of the baseline CO₂ emissions.

An amount of dissolvable addifeed (for example, CaCO₃ or an equivalent) can be added to increase alkalinity in the treatment process up to a maximum of where carbon dioxide (CO₂) volatilization is driven to less than 50% of the baseline CO₂ emissions.

An amount of dissolvable addifeed (for example, CaCO₃ or an equivalent) can be added to increase alkalinity in the treatment process up to a maximum where a pH level of the biomass in the treatment process or the treated effluent from the process reaches an upper pH limit threshold less than 9.0, thereby reducing carbon dioxide (CO₂) stripping during the treatment process.

In various embodiments the dissolvable addifeed (for example, CaCO₃ an equivalent) can be added to act as a ballast or a stratum for biofilm, the process or processor can include an activated sludge process or an aquaculture process or a process for any form of culturing, and/or the solid-liquid separator can include either a clarifier, a filter, dissolved air floatation unit or a membrane separator.

In various embodiments the processor can include a solid-liquid separator comprising a membrane bioreactor and/or the dissolvable addifeed (for example, CaCO₃ or an equivalent) can be added for decreasing CO₂ emissions and additional benefits for membrane fouling resistance and increases in membrane permeability.

The dissolvable addifeed (for example, CaCO₃ or an equivalent) can be added to increase Ca²⁺ concentrations relative to concentrations of Na⁺ and/or K⁺ in the treatment process to improve settling and/or biological phosphorous (P) removal conditions.

The dissolvable addifeed can include magnesium (Mg) solids that increase Mg²⁺ concentrations relative to concentrations of Na⁺ and/or K⁺ in the treatment process to improve settling and/or biological phosphorous (P) removal conditions.

The dissolvable addifeed (for example, CaCO₃ or an equivalent) can be contaminated with magnesium (Mg) solids. The addifeed, or magnesium (Mg) solids, can include magnesium oxide (MgO) or magnesium hydroxide (Mg(OH)₂). The magnesium solids could be dolomitic or any form of natural mineral supporting magnesium in a particulate form.

The culturing or treatment process can include at least one of: a suspended growth activated sludge process; a granular sludge process; an integrated fixed film activated sludge process; a biological nutrient removal process; a membrane bioreactor process; a moving bed biofilm reactor process; a fermenter, an aerobic digestion process; and/or an anaerobic digestion process, an aquaculture process, a fungiculture process or a bacterial culture process. The reactor can include a plug-flow reactor, a complete mix reactor, or other suitable reactor as those skilled in the art will understand.

The physical sequestrator can be internal or external to the processor. The internal sequestrator can be a surface wasting device, a flow source, a mixing source, a stratification approach, a gas source or a differential approach. It could be a clarifier, a lamella or any such device that could provide a gravity or classification approach of a fraction with a desired wasting ratio of wasted vs selected of 0 to 50%.

A portion of the solids and undissolved addifeed (for example, CaCO₃ or an equivalent) can include substantially all solids and undissolved addifeed in the biomass.

The treated effluent includes an increase in the dissolved Ca²⁺ concentration proportional to the amount of alkalinity generated and the amount of CO₂ emissions prevented by the dissolution of addifeed (for example, CaCO₃ or equivalent) in the treatment process.

According to an aspect of the disclosure, a method is provided for culturing or for treating water or wastewater. The method comprises: receiving an influent containing water or wastewater; receiving an additive comprising an addifeed; supplying the influent and the addifeed to a culturing or treatment process containing a solid-liquid mixture; adding the influent and the dissolvable addifeed to solid-liquid mixture to form a biomass mixture; processing by the culturing or treatment process the biomass mixture to form a biomass; outputting from the culturing or treatment process the biomass; operating a physical sequestrator to select solids having predetermined characteristics and undissolved addifeed, output non-sequestrated and non-selected solids as a waste stream, retain the selected solids and the sequestrated undissolved addifeed, and output the selected and sequestrated solids and the undissolved addifeed as a recycle stream; and supplying the recycle stream to the culturing or treatment process.

The method can comprise: separating solids and liquids, including solid-liquid separation of the biomass into a first portion comprising solids with undissolved addifeed and second portion comprising a liquid or a liquid mixture; supplying the first portion comprising the solids with undissolved addifeed (for example, CaCO₃) to the physical sequestrator; and/or supplying the second portion comprising the liquid or the liquid mixture as an effluent.

The solid-liquid separation can consist of separating by a settling tank or a clarifier the biomass into a first portion comprising solids with undissolved addifeed and second portion comprising a liquid or a liquid mixture.

The solid-liquid separator can include one or more of a settling tank, a lamella clarifier, a filter, a dissolved air floatation or a membrane. The physical sequestrator comprises one or more of a density, size, shear or compressibility sequestrator. The physical sequestrator can comprise one or more of a hydrocyclone, a screen, a filter a centrifuge, a lamella, a surface wasting device, or a clarifier, any of which can be connected in parallel or in series.

In some embodiment, the addifeed can be received from an external source or the recycle stream. The addifeed can be received at an input located upstream of the treatment process. The addifeed can be an industrial waste source.

The dissolution time can include a time period during which nearly all undissolved addifeed (for example, CaCO₃) is dissolved in the treatment process. The dissolution time can be in seconds, minutes, or days. The use of a physical sequestrator or pre-sequestrator is most beneficial when the dissolution time needed exceeds the solids residence time of the processor. This is an instant disclosure of the invention.

The method can include continuously sequestrating and retaining undissolved addifeed to provide continuous dissolution of addifeed such as, for example, calcium carbonate (CaCO₃), in the treatment process.

In the method, the physical sequestrator can be configured to continuously select and retain undissolved addifeed to provide continuous dissolution of addifeed, including calcium carbonate (CaCO₃), in the treatment process.

The method can include: controlling an amount of undissolved addifeed in the treatment process to increase or maintain a pH level of the biomass in the treatment process below a pH limit threshold, wherein the pH limit threshold is 9.0; controlling the amount of dissolvable addifeed added to the treatment process to reduce carbon dioxide (CO₂) stripping in the treatment process; and/or adding an amount of dissolvable addifeed in the treatment process to increase alkalinity in the treatment process up to a maximum where a pH level of the biomass in the treatment process reaches a pH limit threshold, wherein the pH limit threshold is less than 9.0.

In the method, the dissolvable addifeed can be added to act as a ballast for solids removal; the treatment process can include an activated sludge process; the gravimetric sequestrator can include a clarifier or a classifier; the treatment process can include operation of a membrane bioreactor; and/or the dissolvable addifeed is added for membrane permeability and fouling resistance in the membrane bioreactor.

The method can include: adding the dissolvable addifeed to control Ca²⁺ concentrations relative to concentrations of Na⁺ and/or K⁺ in the treatment process; controlling, by the physical sequestrator, the amount of undissolved addifeed, wherein the controlling comprises controlling the retention time of solids and undissolved addifeed in the physical sequestrator; and/or adding dissolvable addifeed containing Magnesium (Mg) solids that increase Mg²⁺ concentration relative to concentrations of Na⁺ and/or K⁺ in the treatment process.

In the method, the physical sequestrator can be configured to control the amount of undissolved addifeed in the treatment process, the dissolvable addifeed can include, or it can be mixed or contaminated with, magnesium (Mg) solids, the magnesium (Mg) solids can include magnesium oxide (MgO); and/or the treatment process or processor can include at least one of: a suspended growth activated sludge process; a granular sludge process; an integrated fixed film activated sludge process; a membrane biofilm process, a membrane aerated biofilm process, a biological nutrient removal process; a membrane bioreactor process; a moving bed biofilm reactor process; a fixed film process, an anaerobic process, an aerobic digestion process; and an anaerobic digestion process.

The method can include precipitating calcium phosphates (including and not limited to brushite or hydroxyapatite) for chemical phosphorus (P) removal as calcium carbonate (CaCO₃) and any product bicarbonate is dissolved.

The method can include precipitating magnesium phosphates (including and not limited to struvite) for chemical phosphorus (P) removal as equivalent calcium carbonate (CaCO₃) and any product bicarbonate is dissolved.

In the method: dissolution of the addifeed (for example, CaCO₃ or equivalent) in floc in the treatment process can adsorb phosphorus and/or drive P precipitation in the core of a densified floc or granule for phosphorus (P) removal; the addifeed can be formulated to provide size distribution to balance speed of dissolution for alkalinity, carbon dioxide (CO₂) capture, alkalinity for BNR, sending alkalinity to downstream BNR, or larger size, wherein the dissolution rate is balanced for settling sequestration and phosphorus removal; the dissolution speed can be balanced for nutrient removal, carbon capture, intensification, or phosphorus removal; the physical sequestrator or gravimetric sequestrator or screen sequestrator can be linked to a grain size distribution fraction of the addifeed; the addifeed can be formulated to optimize CaCO₃ dissolution kinetics in relation to hydraulic retention time (HRT), solids retention (or residence) time (SRT), nutrient removal, or carbon capture; the solid-liquid separator can be configured to select undissolved addifeed (for example, CaCO₃) and any ballasted solids based on settling velocity; the solid-liquid separator can include a clarifier for separating the undissolved addifeed and any ballasted solids from overall solids collection or slower settling fraction; and/or the clarifier comprises a rectangular clarifier with a hopper or a circular clarifier with more than one return activated (RAS) draw off.

Additional features, advantages, and embodiments of the disclosure may be set forth or apparent from consideration of the detailed description, which includes the drawings. Moreover, it is to be understood that the foregoing summary of the disclosure and the following detailed description and drawings provide non-limiting examples that are intended to provide further explanation without limiting the scope of the disclosure as claimed.

### DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and the various ways in which it may be practiced.

FIG. 1A illustrates a nonlimiting embodiment of an apparatus and system, constructed according to the principles of the disclosure. In various embodiments the apparatus and system include a solid-liquid separator that can include either a clarifier in the case of activated sludge or a membrane separator in the case of a membrane bioreactor (MBR). In some embodiments, the solid-liquid separator includes dissolved air floatation, a filter, or other solid-liquid separator device or process. In the case of a chemostat, a solid-liquid separator is not needed.

FIG. 1B illustrates a nonlimiting embodiment of the apparatus of system of FIG. 1A that includes one or more sensors and a controller, constructed according to the principles of the disclosure.

FIG. 1C illustrates a nonlimiting embodiment of an apparatus and system, constructed according to the principles of the disclosure.

FIG. 2 illustrates another nonlimiting embodiment of the apparatus and system, constructed according to the principles of the disclosure.

FIG. 3 illustrates another nonlimiting embodiment of the apparatus and system, which can include a membrane bioreactor (MBR), according to the principles of the disclosure.

FIG. 4 illustrates another nonlimiting embodiment of the apparatus and system, which can include an MBR with an optional return activated sludge (RAS) location, according to the principles of the disclosure.

FIG. 5 illustrates another nonlimiting embodiment of the apparatus and system, which can include multisequestration or multidesequestration, according to the principles of the disclosure.

FIG. 6 illustrates another nonlimiting embodiment of the apparatus and system, including multisequestration or multidesequestration, according to the principles of the disclosure.

FIG. 7 illustrates another nonlimiting embodiment of the apparatus and system, including multisequestration or multidesequestration, according to the principles of the disclosure.

FIG. 8 illustrates a nonlimiting embodiment of a process for water or wastewater treatment, including dissolution of an addifeed to provide alkalinity (ALK) and decrease carbon-dioxide (CO₂) emissions, according to the principles of the disclosure.

FIG. 9 illustrates a nonlimiting embodiment of a deep tank that can be included in the apparatus and system, according to the principles of the disclosure.

FIG. 10 illustrates a nonlimiting embodiment of a tank and cover that can be included in the apparatus and system, according to the principles of the disclosure.

FIG. 11 illustrates another nonlimiting embodiment of the apparatus and system, according to the principles of the disclosure.

FIG. 12A illustrates another nonlimiting embodiment of the apparatus and system, according to the principles of the disclosure.

FIG. 12B illustrates another nonlimiting embodiment of the apparatus and system, according to the principles of the disclosure.

The present disclosure is further described in the detailed description that follows.

### DETAILED DESCRIPTION OF THE DISCLOSURE

The disclosure and its various features and advantageous details are explained more fully with reference to the non-limiting embodiments and examples that are described or illustrated in the accompanying drawings and detailed in the following description. Features illustrated in the drawings are not necessarily drawn to scale, and features of one embodiment can be employed with other embodiments as those skilled in the art will recognize, even if not explicitly stated. Descriptions of well-known components and processing techniques may be omitted so as to not unnecessarily obscure the embodiments of the disclosure. The examples are intended merely to facilitate an understanding of ways in which the disclosure can be practiced and to further enable those skilled in the art to practice the embodiments of the disclosure. Accordingly, the examples and embodiments should not be construed as limiting the scope of the disclosure. Moreover, like reference numerals represent similar parts throughout the various views of the drawings.

In wastewater treatment systems and processes, including those described in U.S. Pat. Nos. 9,242,882, 9,670,083, and 11,999,641, incorporated by reference herein, or in biological culturing processes (such as used for culturing procaryotes, eukaryotes or archaea, including and not limited to aquaculture, fungiculture and bacterial culture), the addition of an addifeed (including, for example, calcium carbonate (CaCO₃) or its equivalent) can improve culturing, including, but not limited to, nitrification and biological phosphorus removal by increasing the alkalinity and pH of the wastewater or the culture. The sequestrator can perform a dual role as a selector, however in the case of a sequestrator, its objectives are to specifically improve the dissolution of addifeed including as a pre-sequestrator, a physical sequestrator, a chemical sequestrator, an internal sequestrator or an external sequestrator) and to thereby further to sequester carbon dioxide through such improved dissolution. The role and objectives of a selector is to select for organisms and morphologies that are beneficial for processing (including bacteria, archaea or eukaryotes) including for treatment or culturing and to deselect (or out-select) organisms that are not beneficial. The deselected organisms are wasted or often called waste activated sludge. WAS and wasted organisms can be used interchangeably.

It is noted that in various embodiments any reference to addifeed or CaCO₃ in this disclosure also refers to any mineral carbonates or other anionic substances (supported by any cation including, alkaline minerals, alkaline earth minerals, calcium, magnesium, iron, aluminum, or combinations thereof that are natural minerals or artificial minerals) that are either particulate or colloidal (including and not limited to micron and nano size particles) in nature. It is also noted that in various embodiments the reference to addifeed or CaCO₃ in this disclosure includes the use of metal oxides or metal hydroxides or any natural or synthetic mineral material that enhances alkalinity in particulate or colloidal form, which on dissolution generate alkalinity and decrease the emission of carbon dioxide. In this disclosure, any reference to addifeed or CaCO₃ (addition or management) can include any equivalent thereof, including, for example, equivalent calcium carbonate as CaCO₃, or its alkalinity equivalence (eq or meq) and (often described as mg as CaCO₃ or mg/L as CaCO₃) or alkalinity containing mineral of natural or synthetic form that is particulate or colloidal, and where 1 meq of alkalinity is 50 mg of CaCO₃.

Increased pH levels create favorable conditions for the organisms or microorganisms responsible for these processes in the processor and enhances their activity. These improved activity conditions from a change in pH often support protonation or deprotonation of chemical compounds that are either a beneficial substrate, cosubstrate or become less inhibitory or toxic to the organisms or microorganisms. Furthermore, increased pH reduces carbon dioxide (CO₂) stripping during biological treatment, consequently decreasing greenhouse gas emissions from the process. This reduction in CO₂ stripping can be monetized in the form of a carbon credit. The inventors have discovered that dissolution of the added addifeed is instrumental in achieving these benefits. Furthermore, the addition of a physical sequestrator or pre-sequestrator serves to minimize the addifeed lost to the waste activated sludge line, keeping the added chemical in the process allowing for more complete dissolution, alkalinity generation, and further reduction in CO₂ stripping and cost savings. The use of addifeed supported by physical sequestrators or pre-sequestrators can replace the use of caustic, an expensive chemical to support pH management.

An article by Stacy Kauk, entitled “New Protocol for Carbon Removal via Wastewater,” dated Nov. 18, 2024 and published at <<https://isometric.com/writing-articles/new-protocol-for-carbon-removal-via-wastewater>>, describes a protocol for carbon dioxide removal (CDR) via wastewater alkalinity enhancement (WAE).

Also, the Crew Carbon company (<<https://crewcarbon.com>>) appears to use natural minerals in certain treatment processes to dissolve and permanently lock CO₂ into a stable ion that is environmentally inert. Their approach is espoused as improving wastewater treatment by removing the cost barrier for typical pH and alkalinity optimization, thereby providing safer and more effective improvements.

The inventors have discovered that addifeed addition to a wastewater treatment or culturing process equipped with a biological selector and/or a physical sequestrator (such as, for example, a gravimetric sequestrator, density or screen sequestrator) can also facilitate marine carbon dioxide removal (mCDR) by discharging alkaline wastewater. This enhanced dissolution of carbonate minerals is an inventive step that can be optimized by the use of a sequestrator as herein disclosed and can also be monetized in the form of a carbon credit by known protocols.

The inventors have discovered that addifeed added to a wastewater treatment or culturing system or process (in any part of a plant, including activated sludge, a fermenter, or a digester) may not fully dissolve during a treatment or culturing process, potentially limiting its effectiveness. The instant disclosure provides a system, a method, and a system for improving settling of solids and maximizing the dissolution of addifeed₃ through physical sequestration such as gravimetric sequestration or screen sequestration. By retaining undissolved addifeed₃ and minimizing loss to the waste activated sludge line, physical sequestration allows more time for full or fuller dissolution to maximize the benefits of addifeed addition. Furthermore, the undissolved addifeed can act as a ballast for improved settling. For example, addifeed can be used as a ballast in the system described in U.S. Pat. No. 9,670,083, incorporated herein. The fuller dissolution of the addifeed can provide divalent cations for improving settling and dewatering or provide counter ions for enhanced biological phosphorus removal. The addifeed can also be a framework for biofilm or granule formation with the inorganic carbon or its counterion dissolution providing a counter diffusion framework for organisms that seek to use such materials for their assimilatory or dissimilatory needs.

In various embodiments, a water treatment technology is provided that includes a system, an apparatus, and a methodology for optimizing water and wastewater treatment. The technology includes a processor for biological treatment or culturing that combines input water or wastewater, recycled or retained biomass and recycled or retained CaCO₃ and outputs a waste stream to a physical sequestrator. The physical, chemical or biological sequestrator can include an internal or external sequestrator, including and not limited to a gravimetric (or any gravity/density) sequestrator and/or a screen (or any size or shear) sequestrator and/or an approach to improve capture or minimize volatilization of CO₂ within wastewater treatment (including and not limited to activated sludge process). The system can include, for example, one or more covers or cover add-ons for such sequestration, and/or a purposeful deep column. The cover add-ons can include temporary or permanent hoods (including polymeric or plastic or fiberglass) to hold or evacuate CO₂. The use of covers are an embodiment sequestrator to improve solubility of addifeed including minerals.

In some embodiments, the internal sequestrator can include a physical sequestrator that increases the solids residence time or dissolution of alkaline minerals (such as by shear, mixing, settlement, dead zones, stratification (within reactor zones), baffles, walls, recycling of settled or stratified materials, covers, head/pressure). The internal sequestrator can include a device or process that creates and manages temperature differentials (heat addition) or creates and manages micro or macro zones for such mineral dissolution or carbon dioxide sequestration.

In various embodiments, CaCO₃ is fed to an input upstream of the processor or directly to the processor. The input can include an influent comprising water or wastewater. The system can include a pre-sequestrator for dissolution of CO₂. The processor facilitates biological treatment or culturing of the water or wastewater and outputs processed water or wastewater to an input of the physical sequestrator, which selects solids with superior settling characteristics and/or retains any undissolved CaCO₃. An output of the physical sequestrator is directed to and supplied to a recycle stream. The system may include another output of the physical sequestrator, which may comprise directing a waste stream at the second output of the physical sequestrator to solids handling.

In one embodiment, the input is sludge that is fed into a sludge processor and retained CaCO₃ using a physical sequestrator as previously described herein. The sludge processor could be a fermenter, digester, holding tank or any approach where an improved dissolution is desired using any form of physical sequestrator (including a recuperative thickener).

The waste stream of the physical sequestrator may contain solids with poor settling characteristics, while the first output of the physical sequestrator contains solids with superior settling characteristics along with CaCO₃ that remains undissolved. In various embodiments, the physical sequestrator can include one or more gravimetric sequestrators and/or screen sequestrators. The gravimetric sequestrator can include, for example, a clarifier, a settling tank, a cyclone, a hydrocyclone, a centrifuge, a gravity settling device, a classifier, or other device that facilitates sequestration of particles from a mixture based on density or gravity or size.

In one embodiment, the system can include supplying addifeed at any location in the wastewater treatment process, including in sewers, industrial flows, agricultural flows, combined sewer flows, or any form of such upstream addition that realizes in such downstream a sequestration benefit. The system can include a pre-sequestrator at an upstream location for the express purpose of CO₂ sequestration in that upstream source while the rate or solids properties or processing improvement could occur in a downstream processor as previously described within an apparatus.

In one embodiment, the dissolution of mineral carbonates or discharge of alkaline water can be associated with balancing any acidic or acid producing streams discharged by any centralized systems (such as any industries or water production systems) or decentralized systems in a calibrated manner to provide one or more of an accounting, mitigation, benefit or credit that to such centralized or decentralized upstream systems within the wider watershed or sewer shed entering the wastewater system prior to the discharge of such alkaline water.

In one embodiment, the system can include an oxygen supply source to reduce the stripping of CO₂. The oxygen supply source can include, for example, an internal or external source of pure oxygen (including, but not limited to, its production from electrolysis), nanobubbles, deep tanks or covered tanks. The use of CaCO₃ can ameliorate such effects of acidification while producing alkalinity (ALK) and increased pH levels needed for effective biological treatment. Conversely, the purposeful use of pure oxygen and/or covered tanks can promote the internal physical sequestration (i.e. chemical dissolution by using physical covers or physical oxygen dissolution devices/mixers) of supplied addifeed and to thereby sequester carbon dioxide.

In an embodiment, the addifeed can be introduced as a dry, semi solid or slurry (collectively in the embodiment called slurry) and the slurry can be acidified or preacidified in a pre-sequestrator using a CO₂ flux from a processor (biological reactor) or any other CO₂ sequestration source in the treatment plant, sewer or any water source, such as from industry, that eventually comes to the processor. The system can include a covered pure oxygen tank having a vent of CO₂ that is then introduced to a pre-sequestrator and dissolved in aforementioned approaches, which can include a pressure tank, a mixer, a sparger, a carbonator. The system can include a pre-sequestrator configured to either passively or actively dissolve the CO₂, wherein the pre-sequestrator can include a slurry tank placed anywhere in the stream (upstream, midstream, recycle or return stream or downstream of a processor/biological reactor).

In an embodiment of the system using pure oxygen in the processor, the headspace of the pre-sequestrator (such as CaCO₃ slurry tank) and the vented processor/bioreactor can be connected (directly or indirectly) to help with CO₂ dissolution while simultaneously maximizing oxygen dissolution (pure oxygen is expensive and the desire is to dissolve and use it maximally in the processor).

In an embodiment, the system can include preacidification of slurry using CO₂ to optimize particle size and make the slurry more amenable for dissolution kinetics while sequestering the CO₂. The CO₂ can be obtained from any source in a wastewater treatment plant or culturing plant, or external sources outside of a plant, for this preacidification reaction in the pre-sequestrator thereby improving dissolution of the addifeed In the system, the pre-sequestrator improves rates or solids properties in the processor and, if included for improved dissolution, improve rates or solids properties in additional downstream processors such as, for example, processors configured for solid-liquid separation, thickening, digestion, crystallization (including such solids properties), dewatering, and/or sidestream treatment.

In some embodiments, the system includes an oxygen purification device or electrolysis device and/or mixers, venturis, pumps and/or diffusers that supplies and dissolves pure oxygen at flow rates and in amounts sufficient to: 1) improve physical or chemical dissolution of produced carbon dioxide from the biological consumption of such pure oxygen; 2) the preemptive, concomitant or subsequent addition of addifeeds; 3) improve physical, chemical or biological dissolution; 4) sequester carbon; and/or 5) prevent the formation of other greenhouse gases (nitrous oxide or methane). In the system, the headspace of the processor can be directly or indirectly connected to the pre-sequestrator (such as, for example, CaCO₃ slurry tank) for the pre-dissolution of headspace or vented CO₂. A physical, chemical or biological sequestrator for improvements to addifeed and/or carbon dioxide dissolution can be an optional part of the system. The sequestrator can include a gravimetric sequestrator. The use of pure oxygen from a carbon neutral electrolysis source and the sequestration of produced carbon dioxide from such a source is an instant disclosure for managing the carbon footprint using culturing water systems. The water source for such electrolysis is optionally the produced water from such treatment itself.

In some embodiments, the system includes an oxygen purification device, electrolysis device, or truck-delivered liquid oxygen system that supplies pure gaseous oxygen at flow rates and in amounts sufficient for the oxygen requirements of the system and its processes, including use of oxygen to: 1) intensify the biological process; 2) increase the retention of carbon dioxide with the one or more covers; 3) support biological consumption of pure oxygen and/or thereafter the preemptive, concomitant or subsequent addition of addifeed, resulting in improved physical, chemical or biological dissolution; and 4) thereby, sequester carbon or prevent the formation of other greenhouse gases (for example, carbon dioxide, nitrous oxide or methane). The system can optionally include a physical or chemical sequestrator or pre-sequestrator to improve addifeed and/or carbon dioxide dissolution. A biological selector is also optional.

In various embodiment, the screen sequestrator can include, for example, a fine screen, a microscreen, a membrane, a drum screen, a step screen, a moving screen, or other device that facilitates sequestration of particles from a mixture based on particle size or particle compressibility. Particle compressibility includes a coefficient β of compressibility of a solid or a particle or solid, which can be a function of an instantaneous volume change ∂V of a solid or a particle as a response to a pressure change ∂p, which can be expressed as:

$$β = - \frac{1}{V} \frac{\partial V}{\partial p}$$

where V is the volume of the solid or particle and p is the pressure applied to the solid or particle. Particle compressibility can include a change in dimensions (for example, width, thickness, height, length) of the solid or particle as a response to the pressure change.

In various embodiments, the processor may include a suspended growth activated sludge process, a granular sludge process, an integrated fixed film activated sludge process, a biological nutrient removal process, a membrane bioreactor process, a moving bed biofilm reactor process, an aerobic digestion process, an anaerobic digestion process, or a fermentation process.

In certain embodiments, the system may comprise a processor and a solid-liquid separator with the physical sequestrator positioned between the processor and the solid-liquid separator from where the wasting can occur at the overflow of the physical sequestrator and the return occurs from the underflow of the solid-liquid separator; or even after the solid-liquid separator (such as a downstream filter) from where the wasting could occur from the backwash of such filter. The wasting that is achieved can consist of material that does not contain an abundance of CaCO₃, which is preferentially recycled for continued dissolution. The physical sequestrator can be installed in a waste sludge line and configured to directly waste from the mixed liquor, or it can be installed in a return activated sludge (RAS) line. Addifeed or CaCO₃ addition may occur either (or both) at the input of the processor or in the recycle stream. In at least one embodiment, addifeed or CaCO₃ addition may occur in a recycle stream output by a physical sequestrator. The technology can combine biological selection and/or physical sequestration with the retention of CaCO₃ for continued dissolution, thereby providing significantly greater alkalinity generation and more carbon credits, and less CaCO₃ ending up in waste solids compared to state of the art wastewater treatment technologies.

The system results in a significant increase in Ca²⁺ concentrations (and Mg²⁺) relative to Na⁺ and K⁺ compared to state-of-the-art wastewater treatment technologies. This decrease in the monovalent to divalent cation ratio enhances settling and dewatering properties of wastewater by enabling divalent cations to bridge negatively charged cells and extracellular polymeric substances. Consequently, higher divalent cation concentrations facilitate the formation of denser, more shear-resistant flocs, which lead to improved effluent quality and reduced conditioning requirements during solids handling.

Background on monovalent to divalent cation ratio can be found in the article titled “The Effect of Cations on The Settling and Dewatering of Activated Sludges: Laboratory Results,” by Higgins, M. J., & Novak, J. T. (1997), published in the Water Environment Research, 69(2), 215-224. Additional background can be found in the article by Bruus, J. H., Nielsen, P. H., & Keiding, K., titled “On The Stability of Activated Sludge Flocs With Implications to Dewatering,” published in the Water Research, 26(12), 1597-1604 (1992).

In certain embodiments, the technology can also include lower quality CaCO₃ contaminated with Mg solids including MgO or Mg(OH)₂. In certain embodiments, the technology can also include Ca and/or Mg solids including CaO, MgO, Ca(OH)₂ or Mg(OH)₂ such as from waste or recycled products.

In various embodiments, the system can include a membrane bioreactor (MBR) with biological selection and/or physical sequestration. The membrane bioreactor can include a combination of a bioreactor and a membrane module. The use of CaCO₃ along with a physical sequestrator can provide benefits for reducing fouling, improve fouling mitigation, improving flux or extending the life of the membrane. A solid-liquid mixture may flow first through the bioreactor, where it may be held for as long as necessary for the reaction to be completed, and then through the membrane module without the need for a clarification step.

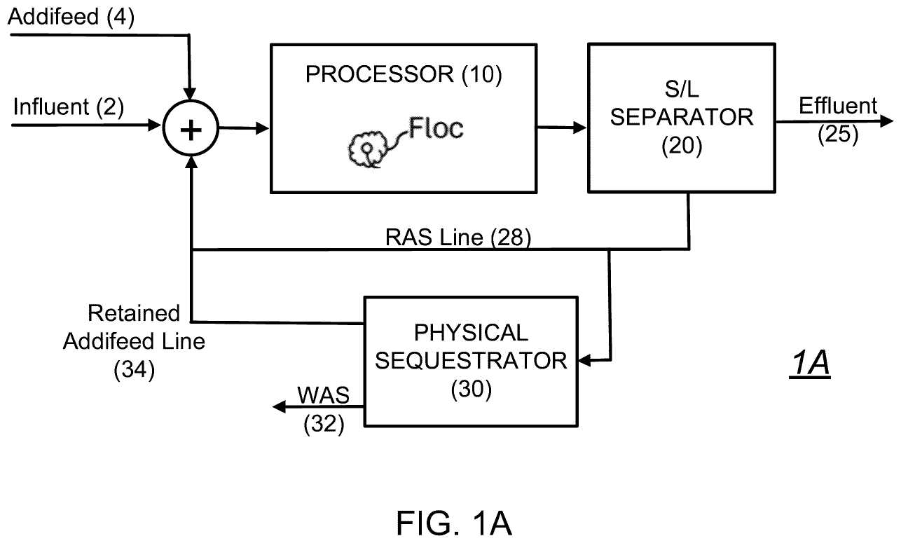

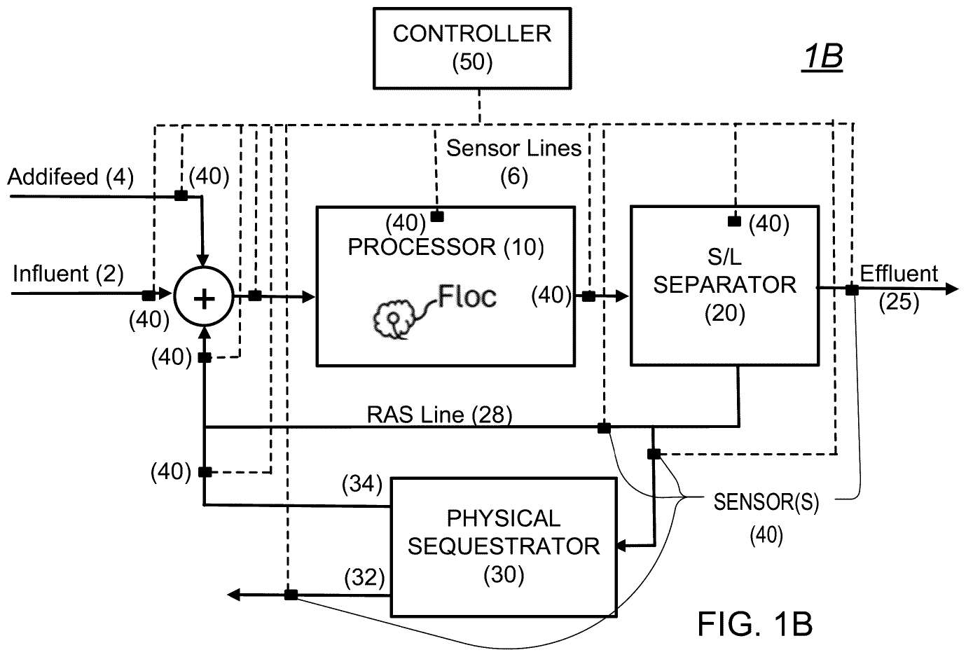

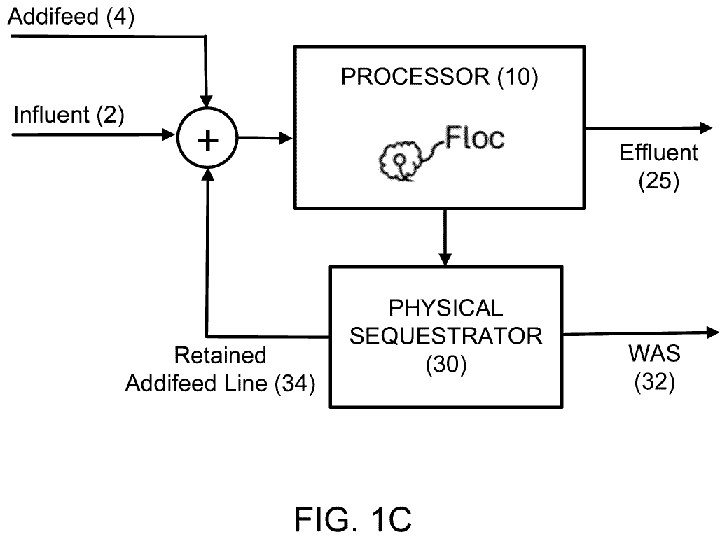

FIG. 1A shows a nonlimiting embodiment of an activated sludge system or a biological culturing system 1A, including an activated sludge process (or culturing process) flow, according to the principles of the disclosure. The system includes a processor 10, a solid-liquid (S/L) separator 20, and a physical sequestrator 30. An influent 2 is received at an upstream end of the processor 10 and, after adding an addifeed 4 (for example, CaCO₃ or its equivalent) from a supply source (not shown) of addifeed to the influent 2, the influent 2 with addifeed 4 is supplied to an input of the processor 10 for treatment processing. The addifeed 4 can be added to the influent or directly to the processor 10. The retained addifeed line 34 returns the undissolved addifeed wither to the influent 2 or directly to the processor 10. The waste activated sludge (WAS) 34 is an output of the physical sequestrator 30. The effluent 25 is a clarified and treated output from the solid-liquid separator that has benefited from the improved treatment and solids properties engendered by the physical sequestrator from such addition and improved dissolution of the addifeed, improved dissolution of CO₂ or in some cases managed dissolution including off gassing of CO₂.

FIG. 1C shows a nonlimiting embodiment of an activated sludge system or a biological culturing system 1C, including an aerobic digester, an anaerobic digester, an activated sludge process, and/or a culturing process flow, according to the principles of the disclosure. The system includes a processor 10, and a physical sequestrator 30. There is no solid-liquid separator 20 in this approach. An influent 2 is received at an upstream end of the processor 10 and, after adding an addifeed 4 (for example, CaCO₃ or its equivalent) from a supply source (not shown) of addifeed to the influent 2, the influent 2 with addifeed 4 is supplied to an input of the processor 10 for treatment processing. The addifeed 4 can be added to the influent or directly to the processor 10. The retained addifeed line 34 returns the undissolved addifeed wither to the influent 2 or directly to the processor 10. The waste activated sludge (WAS) 34 is an output of the physical sequestrator 30. The effluent 25 is a treated output that has benefited from the improved treatment and solids properties engendered by the physical sequestrator from such addition and improved dissolution of the addifeed. The WAS 32 and effluent 25 are the same or alternatively combined for a chemostat. In some cases, substantially all of the effluent is output as WAS 32, or substantially all of the WAS 32 is output as effluent.

The sequestrator 30 can be configured to perform as a classifier to classify chemical solids or biological solids to either manage formation of crystals or phosphorus precipitates (such as struvite, brushite and vivianite). The off-gassing or management of carbon dioxide can be managed as needed to improve the formation and/or dissolution of such phosphorus precipitates.

In some embodiments, the sequestrator 30 can be configured as, or include, more than a single sequestrator. The sequestrator 30 can be configured as, or include multiple sequestrators arranged in series, parallel, tributary or distributary arrangement of the sequestrators. The sequestrator(s) 30 can either thicken solids or uncouple the solids residence time (for example, where the solids residence time of retained and classified stream is greater than the solids residence time of discharge or output stream) for biological selection of organisms, in addition to the classification of such chemical and biological solids. In some embodiments, the sequestrator(s) 30 can include a hydrocyclone configured to thicken the solids, such as, for example, in a digester, where the underflow return solids are higher in concentration than the overflow solids output by digester (or hydrocyclone).

The sequestrator(s) 30 can include either (or both) a hydrocyclone or centrifuge to either form or to remove phosphorus precipitates. A hydrocyclone can be used to off-gas or entrain carbon dioxide. A screen can be used to remove precipitates when optionally placed in series with a hydrocyclone or by itself as a sequestrator. The sequestrator herein can perform a combination of optional roles, including dissolution of some minerals, precipitation of some minerals, physical sequestration, chemical sequestration, classification of chemical or biological solids, thickening of solids, or solids residence time uncoupling of such solids.

In an embodiment, the addifeed can be alternatively (or additionally) added to a recycle stream output from the physical sequestrator 30.

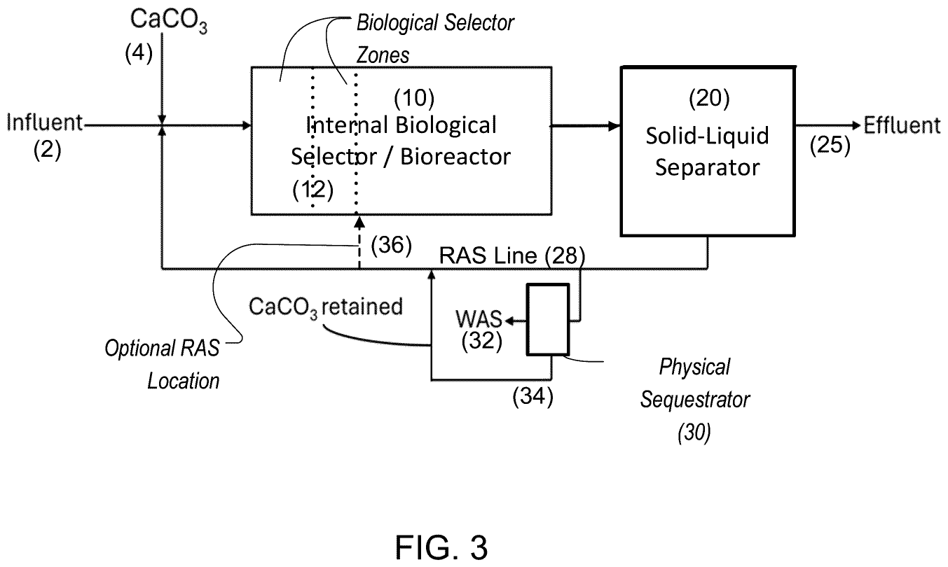

In various embodiments, the processor 10 can include one or more biological selector zones (for example, shown in FIGS. 3-7). The biological selector zones can include any combination of one or more of, for example, an aerobic zone, an anaerobic zone, or an anoxic zone.

A processed mixture containing a solid/liquid mixture (i.e., a liquid-solid mixture and/or a liquid-liquid mixture) is supplied to an output of the processor 10 that is connected to an input of the solid-liquid separator 20. The processed mixture can include undissolved addifeed. The solid-liquid separator 20 can include, for example, one or more clarifiers. The solid-liquid separator 20 can receive the processed mixture and separate solids from liquid in the mixture and output the liquid as an effluent 25 at one output of the solid-liquid separator 20 and the solids or a mixture containing the solids at another output, such as, for example, an underflow output. The separated solids or solids mixture can be output to an input of the physical sequestrator 30, which can include a gravimetric sequestrator and/or a screen sequestrator, or a size, density or shear (including a mixing, pump, gas source device) based sequestrator.

In some embodiments, the processed mixture containing undissolved addifeed (for example, CaCO₃) can be supplied directly, or through one or more intervening devices such as, for example, valves, pumps, tanks (including slurry tanks), clarifiers, filters, and/or screens (not shown), from the output of the processor 10 to an input of the physical sequestrator 30, via one or more supply lines.

The physical sequestrator 30 operates on the solids or solids mixture (or, in some embodiments, the processed mixture) to separate the solids or solids mixture by one or more of a gravimetric sequestration process, a size sequestration process, a shear sequestration process, or a compressibility sequestration process into an effluent 32 that is output at a first output of the physical sequestrator 30 and a solid/liquid mixture containing undissolved addifeed (for example, CaCO₃) that is output at a second output of the physical sequestrator 30 to a retained addifeed (or return) line 34. The effluent 32, which can include a liquid (water) or a liquid-liquid mixture, can be preferentially wasted, either directly or via one or more intervening devices, such as, for example, valves, pumps, tanks, clarifiers, filters, and/or screens (not shown). The return of the addifeed increases the solids residence time of the addifeed relative to the wasted solids to promote its more effective dissolution. The increase in solids residence time of the addifeed through the use of a physical sequestration device is the embodied in the figures.

In certain embodiments, the system can include precipitation of various calcium-phosphate solids for chemical phosphorus (P) removal as addifeed is dissolved to produce alkalinity and available Ca²⁺. In at least one embodiment, addifeed in the floc can adsorb phosphorus and/or drive P precipitation in the core of a densified floc or granule to increase the rate of P removal and the amount of P removed from the system.

In various embodiments the physical sequestrator 30 can be configured to select undissolved addifeed (and ballasted solids) based on settling velocity. The physical sequestrator 30 can include a classifier, which can be similarly configured to a gravity settler, for separating undissolved addifeed (and ballasted solids) from the overall solids collection or, in some embodiments, slower settling fraction. The classifier can include, for example, a rectangular settler with/without a hopper, a circular settler with more than one return activated (RAS) draw off for sequestration of undissolved retained addifeed and/or other return streams, or other classifying settler constructed according to the principles of the disclosure.

In some embodiments, the system includes ballasting by the addifeed or materials that can serve as ballasts, including, for example, plant-based materials or activated carbon. In one embodiment, the ballasting in the system improves settling velocity of bulk solids while also enabling classification of solids to provide ballast-assisted classification of such solids. The system can perform the ballast-assisted classification in a clarifier (not shown), the solid-liquid separator 20, or in the physical sequestrator 30, wherein heavier, denser, or larger solids can be classified for sequestration and selected, or lighter, less dense, or smaller (less ballasted or unballasted) solids can be classified for preferential desequestration and deselected.

In some embodiments, the ballast effect using materials acts to drag or be entrained in larger particles, or allows for a draft of large or more dense particles to improve such classification relative to smaller or less dense particles. In one embodiment the lighter particles are filaments (or light flocs) and/or the heavier particles are granules (or dense flocs).

In various embodiments, addifeed particles are added to the system/process (for example, shown in FIGS. 1A-12B) to provide cores for microbial aggregation, which in aerobic or anaerobic granular sludge encapsulate the addifeed particles and form biomass granules or densified flocs. The center (or core) of such biomass-aggregates will have lower redox-potential due to limited diffusion of oxygen and nitrate, thereby favoring reductive, hydrolyzing and fermentative biological processes that lead to a tentative reduction in the pH-value, which can be buffered by the encapsulated particles, such as, for example, CaCO₃ particles included in the addifeed. This way the retention of biomass-aggregates with encapsulated addifeed particles can contribute to, or be utilized to control, dissolution-management and dissolution-performance.

In various implementations of the systems/processes, microorganisms such as, for example, bacteria and archaea, naturally produce extracellular polymeric substances (EPS)—sticky biopolymers that act like glue. The EPS helps cells stick together and trap fine particles such as addifeed, forming a matrix. Suspended solids and colloidal particles in wastewater get embedded in this EPS matrix. The EPS network creates a protective shell around the particles, leading to a compact structure. Inside the granules, anaerobic zones form due to limited oxygen penetration and outer layers include aerobic zones where oxygen is available. This stratification supports diverse microbial communities that (for example, nitrifiers outside, denitrifiers inside). In various embodiments, the systems/processes are configured to control mixing and hydraulic shear to promote granule compaction (for example, high shear removes loose flocs, favoring dense granules) and to control conditions such as settling times and substrate loading that selects for microorganisms that form granules rather than loose flocs.

In some embodiments, the system is operated to provide and maintain, according to the processes described herein, a differential feast and famine in the processor 10. The system is configured and can be operated to manage formation of granules during feast and to reduce or prevent filaments during famine

In some embodiments, the processor 10 can be configured and operated as an internal physical sequestrator by creating and managing stratification within the processor 10 to sequestrator or deselect particles based on density or size. In one embodiment, the system includes a gas or flow source (not shown) for the stratification of ballasts or ballast-assisted classification of particles, which can be adjusted and controlled by adjusting the gas or flow source.

In some embodiments, the system includes a mixing source (not shown), a gas source (not shown), or a flow source (not shown) to combine ballasting with mixing to improve densification. In certain embodiments, optional stratification can be included, for example, at the upstream end of the processor 10 (such as in an anaerobic selector zone, an anoxic selector zone, or an aerobic selector zone), or in the solid-liquid separator 20, or int the physical sequestrator 30, for ballast augmented classification, wherein the ballast improves differential classification of less and more densified particles for densification. In an embodiment, the influent 2 stream can be directed to the bottom of one or more of the anaerobic, anoxic, or aerobic selector zones such that the larger and denser/heavier solids, which can be diffusion limited, are the first receive the influent 2 in the processor 10.

In various embodiments, the system can include one or more of a variety of gas sources, including, for example, a big bubble mixer, a gas syphon, or other internal (or external) source of gas such as air, oxygen, or other gas. The system can include one or more of a variety of mixing sources, including, for example, a physical mixing device, a hydraulic mixing device, or other internal (or external) mixer. The system can include one or more of a variety of flow sources, including, for example, a recycle, an influent, a liquid, or a gas. The flow source can be directed to any location in the processor 10 or the solid-liquid separator 20.

In various embodiments, the ballasting improves stratification of solids, including with or without mixing sources, gas sources, and/or flow sources, especially, for example, in the downstream end of the processor 10, to allow the heavier, denser, or larger particles/solids that stratify to the bottom to be recycled to the upstream end of the processor 10 to improve addifeed dissolution. In this regard, the system can include a pump or a vacuum (not shown) having an input connected at or near the bottom of the downstream end of the processor 10 and an output connected at or near the top of the upstream end of the processor 10. The lighter, less dense, or smaller particles/solids can be either deselected directly (for example, via a pump) to waste or indirectly via an intervening device (not shown) such as, for example, a lamella, a classifier, an overflow, an internal clarifier, or an external clarifier.

This stratification can be affected by the system at any location in the processor 10 or the solid-liquid separator 20 for a ballast-assist approach, for both dissolution of addifeed as well as particle/solids classification for the purpose of densification or for the retention and build-up of larger or heavier/denser particles/solids.

In some embodiments, the system can include ballasting and addifeed cation dissolution to increase the rate and amount of biological phosphorus removal, for example, by providing the cation as a counter ion for poly phosphates.

In some embodiments, the system includes ballasting and addifeed cation dissolution to overcome poor sludge dewaterablilty resulting from enhanced biological phosphorus removal. Overcoming poor sludge dewaterability can be important for poor alkalinity wastewater found in parts of the world such as, for example, the Pacific Northwest in the United States.

In some embodiments, the system can include an internal physical sequestrator (not shown), such as, for example, between any of the processor 10, the solid-liquid separator 20, and/or the physical sequestrator 30. The internal physical sequestrator includes a particle/solid classifier such as, for example, a mechanical classifier, a lamella, or a sedimentation basin.

In some embodiments, calcium phosphate solids can be precipitated for chemical phosphorus (P) removal as calcium carbonate (CaCO₃) is dissolved by the system. The presence of calcium carbonate (CaCO₃) solids within the floc can sorb phosphorus and/or drive P precipitation in the core of a densified floc or granule for phosphorus (P) removal.

In an embodiment, the addifeed can be formulated to provide size distribution (such as and not limited to being micronized) to balance fast dissolving needs, such as, for example, speed of dissolution for alkalinity, carbon dioxide (CO₂) capture, and alkalinity for biological nutrient removal (BNR). The addifeed can be formulated such that the size of its particles/solids slows dissolution of the addifeed to achieve predetermined settling sequestration and enhance P removal through sorption to addifeed floc core material, intensification, or phosphorus removal. The physical sequestrator 30, which can include one or more gravimetric sequestrators, can be configured to accommodate a larger fraction addifeed (for example, CaCO₃), including a larger grain size distribution fraction of dry addifeed. Using larger grain size addifeed 4 is cheaper and thus the combination of larger grain size and a sequestrator 30 in combination is extremely beneficial to address the dissolution or the managed dissolution of such addifeed 4.

In an embodiment, the addifeed is formulated to optimize CaCO₃ dissolution kinetics in relation to hydraulic retention time (HRT), solids retention time (SRT), nutrient removal, or carbon capture.

In an embodiment, the system includes a reactive stratum for biofilm or granule formation. The addifeed can be included as part of the reactive stratum to facilitate and control biofilm or granule formation, as well as the dissolution of the addifeed in a manner that traps carbon dioxide and/or allows alkaline water to be discharged.

The addiffeed (or CaCO₃) wastage ratio is herein defined as the undissolved addifeed wasted over total addifeed added. Without a physical sequestrator (such as, for example, the physical sequestrator 30 shown in FIGS. 1A and 1B) the addifeed wastage ratio can be as high as 100% (i.e. no dissolution). With the physical sequestrator the addifeed wastage ratio can be as low as 0%. The system, including the physical sequestrator 30, can be configured and operated to decrease the addifeed wastage ratio towards 0% by adjusting and controlling the sequestration/desequestration operation of the solid-liquid separator 20 and/or the physical sequestrator 30. In some embodiments, the solid-liquid separator 20 and/or the physical sequestrator 30 are configured and controlled to achieve a preferred range of addifeed wastage ratio of between 0% and 50%. In certain embodiments, the system is configured and controlled to reduce the addifeed wastage ratio by a minimum of 5%.

FIG. 1A shows another nonlimiting embodiment of an activated sludge system 1B, including an activated sludge process flow, according to the principles of the disclosure. The system includes one or more sensor lines 6, corresponding one or more sensors 40, and a controller 50 in addition to the processor 10, the solid-liquid (S/L) separator 20, and the physical sequestrator 30. In various embodiments, the one or more sensors 40 can be located at any one or more of the located seen in FIG. 1B and configured to measure conditions at that location, including properties of substances (gases, liquids, solids) at the location, and send measurement signals via the sensor lines 6 to the controller 50. Any one or more of the sensor lines 6 can include a wired or wireless medium that conveys data or information between at least two points. The wired or wireless medium can include, for example, a metallic conductor link, a radio frequency (RF) communication link, an Infrared (IR) communication link, or an optical communication link.

Sensor 40 can optionally be an analyzer that is either online or offline. The word sensor and analyzer are used interchangeably in this entire invention disclosure. The one or more sensors 40 can include any combination of, for example, alkalinity sensors, inorganic carbon sensors, temperature sensors, pressure sensors, humidity sensors, flow sensors, flow rate sensors, level sensors, pH sensors, dissolved oxygen (DO) sensors, oxidation-reduction potential (ORP) sensors, turbidity sensors, total suspended solids (TSS) sensors, total dissolved solids (TDS) sensors, conductivity sensors, chemical oxygen demand (COD) sensors, biological oxygen demand (BOD) sensors, specific ion sensors (for example, calcium, ammonium, nitrate, phosphate, chlorine), ultraviolet (UV) sensors, chlorine/residual chlorine sensors, nitrous oxide (N₂O) sensors, and addifeed sensors, which can include, for example, undissolved calcium or mineral carbonate sensors. The sensors 40 can be configured to measure conditions and properties of substances at any one or more locations in the system 1B and send measurement data to the controller 50 via the sensor lines 6. The measurement data can include, for example, temperature, pressure, flow rate, flow velocity, flow amount, humidity levels, acidity/alkalinity levels, DO levels, ORP levels, turbidity levels, TSS levels, conductivity, TDS levels, COD levels, BOD levels, and ion-specific levels (for example, Ca²⁺, NH₄⁺, NO₃⁻, PO₄³⁻, Cl₂). The sensors 40 can assist in carbon accounting and management either directly or indirectly and can be linked to carbon markets via a blockchain.

In various embodiments, the controller 50 is configured to receive and process the measurement data received from the sensors 40 via the sensor lines 6 to assess operation conditions and performance of parts of the system, as well as the entire system, wholistically. The controller 50 is configured, in some embodiments, to adjust the amount of and the rate at which the addifeed 4 is added to the influent 2 based on the operational conditions and performance of various parts of the system, including the processor 10, the solid-liquid separator 30, and the physical separator 40. In an embodiment, the system includes one or more pumps (not shown) and/or one or more valves (not shown) to control the rate and volume of the addifeed 4 added to the influent 2.

The controller 50 includes one or more computers or microprocessors (not shown) configured to interact with the sensors 40, execute computer programs comprising executable code or instructions, process data and store data in a memory storage (not shown). The memory storage (not shown) includes a non-transitory computer-readable storage medium that holds executable or interpretable computer programs, including computer program code or instructions that, when executed by the one or more computers and/or processors (not shown), cause the steps, processes or methods in this disclosure to be carried out.

The addifeed ratio can be calculated by the controller 50 based on measurement signals, including measurement datas of the carbonate alkalinity of the overall biomass at a location in the system (for example, in the processor 10), measurement data of the produced dissolved cation (Ca²⁺ for example), anion or other direct or indirect measures, including, for example, in the mixture in the processor 10 or elsewhere in the treatment process/system. As noted above, the one or more sensors 40 can be configured to measure properties and conditions of the contents in any one or more of the influent 2, the addifeed 4, the processor 10, the solid-liquid separator 20, the effluent 25, the physical sequestrator 30, the retained addifeed line 34, or the WAS 32 and send measurement data to the controller 50, which can determine the effectiveness of the various parts of the system based on the received measurements, including the effectiveness of the physical sequestrator 30 and the addifeed wastage ratio to determine the dissolution of the addifeed. The system can include a soft sensor to provide indirect measurements. Any one or more of the sensors 40 can be configured to take continuous or periodic measurements and send measurement data to the controller 50 in real-time, near real-time, or periodically.

In some embodiments, the addifeed 4 can be added in-real time, near-real-time, or periodically in the system. The addition of addifeed can produce or affect the production of alkaline water, including where the alkalinity is in the form of oxides or hydroxides, and drive the dissolution of carbon dioxide, which can be measured using one or more sensors (not show) in real-time, near real-time, or periodically based on, for example, industrial inputs of chemicals (or the wastes) in an upstream watershed or sewershed. This real-time, near real time, or periodic approach, or any accounting approach thereof can be introduced as part of a ledger, including a distributed ledger or part of a centralized or semi-centralized ledger containing a digital currency.

In various embodiments, the system is configured to receive and process inexpensive and ubiquitous addifeeds such as CaCO₃ that can be processed as a low carbon footprint source of alkalinity but that require addifeed dissolution such as, for example, CaCO₃ dissolution. In some embodiments, the system processes addifeeds such as CaCO₃ for the removal of CO₂ and obtention of related credits, which can require dissolution of addifeeds, including CaCO₃ dissolution. The addition of addifeeds such as mineral carbonates for purposeful carbon sequestration by the system with concomitant improvements in greenhouse gas emissions or autotrophic rates are specifics benefits of the various embodiments of the systems and methods of this disclosure.

In some embodiments, the system processes one or more addifeeds as sources of alkalinity or inorganic carbon for efficient nitrification, reduced nitrous oxide production, and enhanced nutrient removal, any of which can require dissolution of addifeeds, including CaCO₃ dissolution. In these embodiments, of the system can include one or more deep tanks and/or covered tanks. The deep or covered tanks improve the dissolution of addifeeds, including CaCO₃. These deep and covered tanks improve the saturation of carbon dioxide, the dissolution of mineral carbonates and are thus an apparatus (sequestrator) for carbon sequestration.

In some embodiments, the system processes one or more addifeeds to inhibit toxicity by adding addifeeds such as mineral carbonates or hydroxides that influence or are influenced by pH, including, for example, carbonic acid, gaseous carbon dioxide, nitrous acid, and ammonia. In an embodiment, the addifeeds can be processed by the system to provide a source of alkalinity and elevated pH that improve the efficiency of enhanced biological P removal by the system, including by allowing PAOs to better compete with GAOs by dissolution of CaCO₃. Additionally, improved settling or dewatering in the treatment processes can be achieved by the system due to reduction in monovalent to divalent cation ratio by dissolution of the addifeeds, including CaCO₃ dissolution.

In some embodiments, the system can be configured and operated for chemical P removal by adsorption of P onto addifeed particles/solids (for example, CaCO₃ solids) or P precipitates in the floc core with addifeed present. The system can control the rate of P removal and the amount of P removed by controlling addition of the addifeed 4 and/or one or more operations of the processor 10 and the physical separator 30. In certain embodiments, the physical sequestrator 30 is configured or controlled to select and retain solids from the input solid-solid or solid-liquid mixture and output the selected solids to the retained addifeed line 34 at a predetermined rate or range of rates (for example, in liters/second) to achieve a predetermined addifeed wastage ratio value (for example, under 50%) or to maintain the addifeed wastage ration within a predetermined range of values (for example, between 0% and 50%). As discussed above, the addifeed wastage ratio is a function of retaining the undissolved addifeed, including CaCO₃, efficiently in the process.

In one embodiment, the system is configured to control and adjust chemical P removal by controlling the dissolution of addifeed. Since chemical P removal is related to Ca—PO₄ solid precipitation due to high Ca and high pH and alkalinity, the removal can be affected or promoted by addifeed dissolution, including CaCO₃ dissolution.

In one embodiment, the ballast or reactive stratum containing CaCO₃ is maintained by the system as a function of retaining the undissolved CaCO₃ efficiently in the process and the rate of CaCO₃ addition maintains sufficient excess and roughly constant amount of ballast in inventory, with addition rate roughly balancing dissolution/loss rate.

In various embodiments, the system can include any configuration according to the principles of the disclosure, including influent 2, addifeed 4, sensor lines 6, processor 10, internal biological selectors 12, internal sequestrators (stratification zones, covers, deep tanks, lamellas, baffles, mixers, pumps) 18, solid-liquid separator 20, baffles 27, solid-solid separator 20/30, RAS line 28, physical sequestrator 30, WAS line 32, retained addifeed line 34, sensors 40, and/or controller 50, including as depicted in any of FIGS. 1A to 7 and 9-12B.

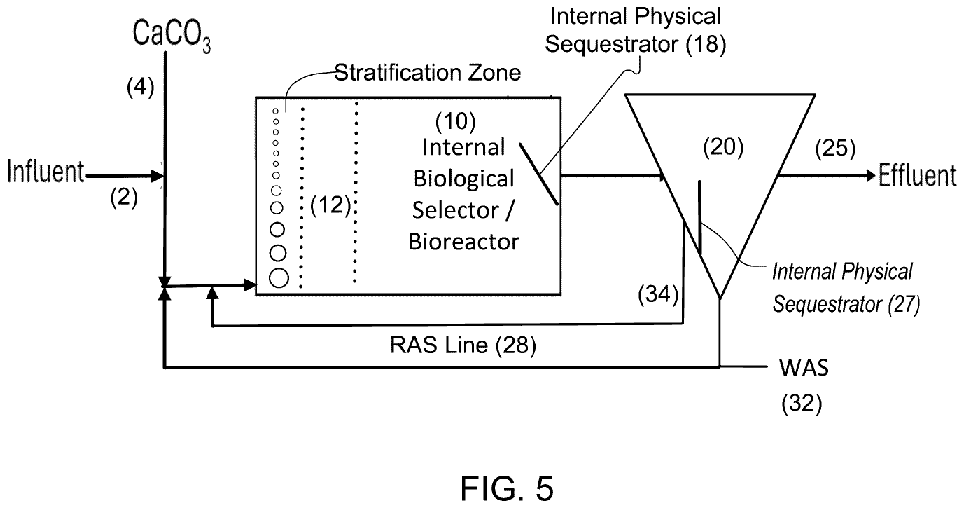

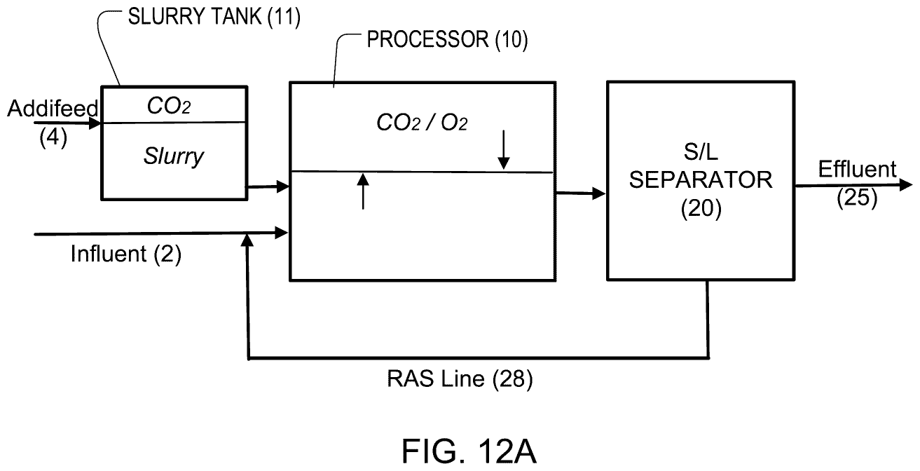

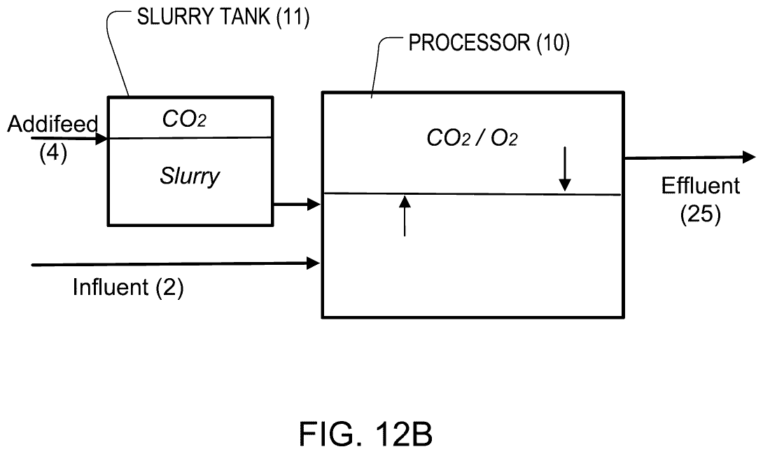

In various embodiments, one or more features and components of any one or more of the systems/processes disclosed herein can be combined with other systems/processes disclosed herein, especially to take advantage of a beneficial flow or processing approach, and especially the use of sequestrators or pre-sequestrator. For example, the systems/processes illustrated in FIG. 1A, FIG. 5 and FIG. 12A can include one or more of any of the pre-sequestrator 11, the internal sequestrator 18, and the physical sequestrator 30, as will be understood by those skilled in the art.

In some embodiments, the system can include one or more of subsystems, which can include any one or more of the configurations depicted in in FIGS. 1A-7 and 9-12. The subsystems can be linked in parallel or series to form the overall system. In certain embodiments, one subsystem can be configured to focus on intensification benefits based on added CaCO₃, and another subsystem can be configured to focus on nutrient removal based on added CaCO₃.

In the embodiments seen in FIGS. 1A and 1B, the second output of the solid-liquid separator 20 comprises an underflow output that is connected to a return line and an input of the physical sequestrator 30. The return line can include a return activated sludge (RAS) line 28. The physical sequestrator 30, which can include one or more gravimetric sequestrators and/or one or more screen sequestrators, can be configured for solid-solid separation. One output of the physical sequestrator 30 can be connected to the return line, either directly or via the retained addifeed line 34, and the other output can be connected to the waste streamline (WAS) line 32. The solid/liquid mixture containing undissolved CaCO₃ can be supplied via the return line from the output of the physical sequestrator 30 to the processor 10, or to a location upstream of the processor 10, for example, as shown in FIG. 1A or 1B.

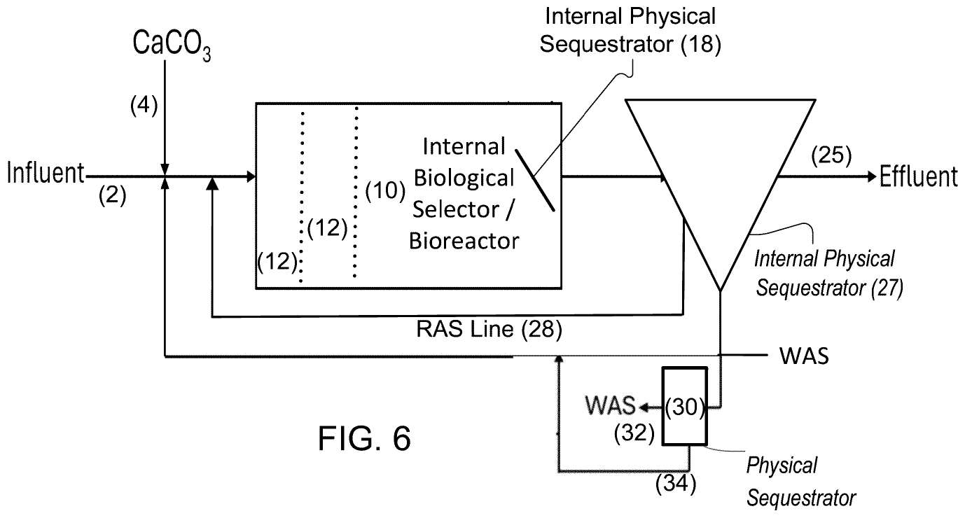

In various embodiments, the solid/liquid mixture with undissolved CaCO₃ can be supplied: in its entirety in the return line as the recycle stream to the processor 10, or to a location upstream of the processor 10; or in its entirety to the physical sequestrator 30, which can include an output 34 at which a recycle stream is output to the return line and another output at which a waste stream is output to the waste stream line (WAS) 32; or partially to the physical sequestrator 30 and partially to the processor 10, or to a location upstream of the processor 10, for example, as shown in FIGS. 1A, 1B, and 6, with the physical sequestrator 30 in each instance having the output 34 at which the recycle stream is output to the return line and the output 32 at which the waste stream is output to the waste stream line (WAS).

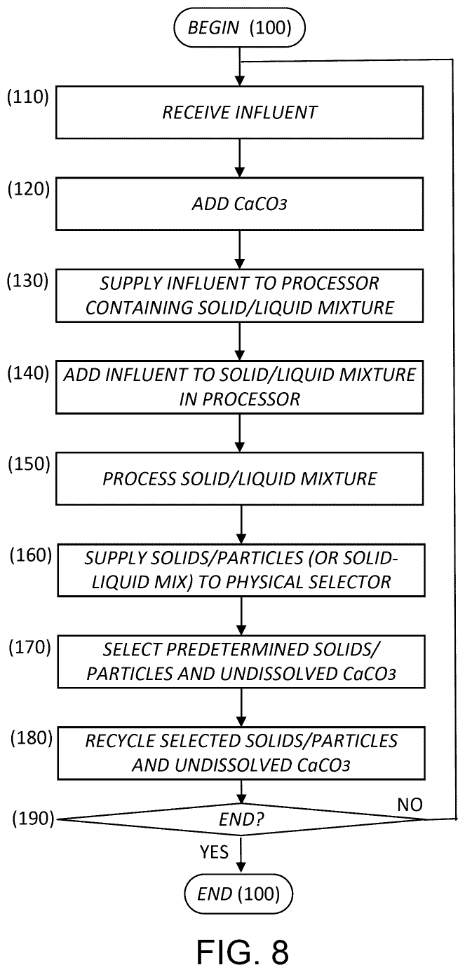

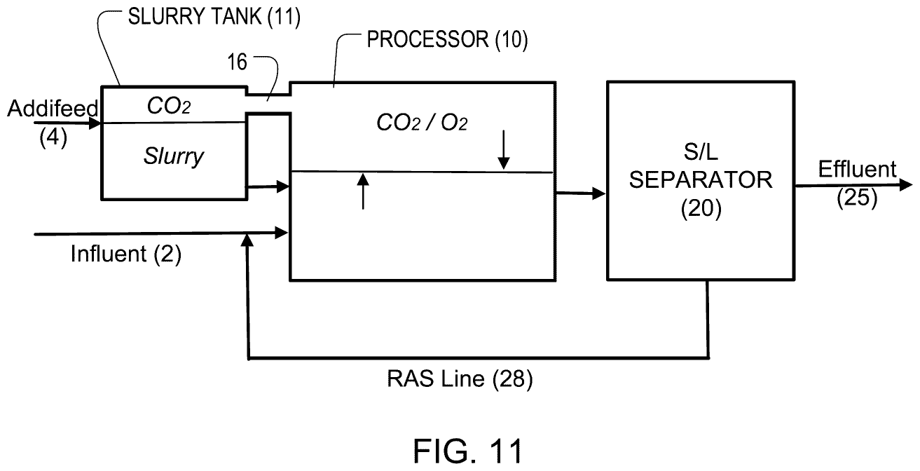

In the embodiments seen in FIG. 1A or 1B, the system and apparatus are configured to perform one or more processes according to the principles of the disclosure, including process 100 (shown in FIG. 8). The system and apparatus comprise the processor 10, the solid-liquid separator 20, the addifeed source 4, and the physical sequestrator 30. The addifeed 4 source can include an optional presequestrator (not shown) that dispenses or otherwise supplies the addifeed 4, including, for example, CaCO₃ or a mineral equivalent of CaCO₃. The physical sequestrator 30 has an input that is connected in parallel with one end of the return line to the second output of the solid-liquid separator 20. The physical sequestrator 30 is configured to: receive a portion of the solid/liquid mixture with undissolved CaCO₃ at its input from the solid-liquid separator 30; select and retain solids or particles (solids/particles) having predetermined characteristics together with undissolved CaCO₃; output at the physical sequestrator 30 output 34 connected to the return line the retained solids/particles with any remaining undissolved CaCO₃; and output the remainder as the waste stream to the output connected to the waste stream line (WAS) 32. The physical sequestrator 30 can be configured to select and recycle any undissolved CaCO₃ and solids/particles that promote granulation and phosphorus and nitrogen removal, while simultaneously facilitating dissolution of the CaCO₃. The pre-sequestrator (for example, 11 shown in FIG. 11 or FIG. 12A or FIG. 12B), which is optional, can be configured to receive CO₂ from any source, including the processor 10 for pre-acidification. In some embodiments, the physical sequestrator 30 can be optional if a pre-sequestrator (for example, 11 shown in FIG. 11, FIG. 12A, or FIG. 12B) is used and vice versa.

In various applications, the physical sequestrator 30 can be configured to select and retain solids/particles having predetermined characteristics such as, for example: a sludge volume index (SVI) less (or greater) than 150 mL/g, 120 mL/g, 80 mL/g, 50 mL/g, 30 mL/g or less; a solid/particle size of less (or more) than 5 mm, 4 mm, 3 mm, 2 mm, 1 mm, 0.5 mm, 0.1 mm, micronized particles, nanoparticles or less; a settling velocity of more (or less) than 30 m/h, 15 m/h, 10 m/h, 5 m/h, or 1 m/h, or less; or other properties that are indicative of solids/particles that can promote granulation (or granule formation) or mobile biofilms, or phosphorus or nitrogen removal or digestion or fermentation, while simultaneously facilitating dissolution of the addifeed or CaCO₃.

In various embodiments: the influent 2 can include water or wastewater received from a source (not shown) such as, for example, a residential, institutional, industrial, commercial, government, or other private or public source of water or wastewater to be treated; the processor 10 can include a combination of one or more of a bioreactor, a membrane bioreactor, an anaerobic membrane bioreactor, an aerobic bioreactor, an anaerobic bioreactor, an up-flow anaerobic sludge reactor, a continuous stirred-tank reactor, an anaerobic fluidized bed reactor, a moving bed biofilm reactor, or other device configured to facilitate biological treatment of water or wastewater; the physical sequestrator 30 can include one or more gravimetric sequestrators, which can include any one or more of a cyclonic device, hydrocyclone, centrifuge, a classifier, a settling tank, a clarifier, a gravity settling device, or other device or source that facilitates sequestration of particles (for example, sequestration of solids having predetermined characteristics from other solids) from a mixture based on density or gravity and size; and the physical sequestrator 30 can alternatively or additionally include on more screen sequestrators, which can include any one or more of a fine screen, a microscreen, a membrane, a drum screen, a step screen, a moving screen, or other device that facilitates sequestration of particles from a mixture based on particle size or particle compressibility. In some embodiments, the physical sequestrator can include one or more gravimetric sequestrators and/or screen sequestrators that facilitate sequestration of particles from a mixture based on compressibility, shear, density and/or size.

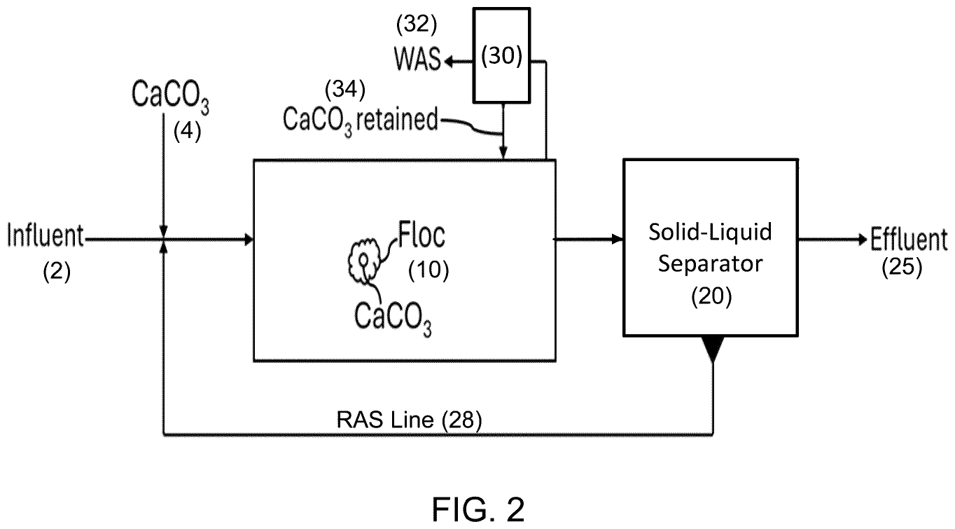

FIG. 2 shows another nonlimiting embodiment of the activated sludge system and the activated sludge process flow according to the principles of the disclosure. As seen in FIG. 2, the physical sequestrator 30 is not installed between the processor 10 and the solid-liquid separator 20, as in the embodiments depicted in FIG. 1A or 1B. Here, both an input and a first output 34 of the physical sequestrator 30 are connected to the processor 10, and another, second output of the physical sequestrator 30 is connected to the waste streamline (WAS) 32.

In some embodiments, including the embodiment depicted in FIG. 2, a bypass can be applied as needed to the feed, overflow, or underflow of the physical sequestrator 30.

In some embodiments, including the embodiment in FIG. 2, the physical sequestrator 30 can be configured to: receive at its input the solid/liquid mixture with undissolved CaCO₃ from an output of the processor 10; select and retain solids/particles having the predetermined characteristics together with any undissolved CaCO₃; return, via its first output 34, a recycle stream containing the retained solids/particles and undissolved CaCO₃ to an input of the processor 10; and output, via its second output 32, the remainder to the waste stream line (WAS) for, for example, solids handling and/or wasting. A bypass can be applied as needed to the feed, overflow, or underflow of the physical sequestrator 30. The apparatus can include a mineral source (not shown) that supplies the addifeed 2 and/or an optional pre-sequestrator 11 that can receive CO₂ from any source, including the processor 10, for pre-acidification. In some embodiments, the physical sequestrator 30 can be optional if a pre-sequestrator 11 is included and vice versa. The main difference in features between FIG. 1A/FIG. 1B and FIG. 2 is the relative placement of the physical sequestrator (30) as an external sequestrator associated with the solid-liquid separator 20 or processor 10. All other embodiments of these figures are interchangeable, including the use of sensors or the benefits from improved dissolutions using such sequestration. A MBR or clarifier or filters or DAFs are options for a solid-liquid separator 20

FIG. 3 shows another nonlimiting embodiment of the activated sludge system, according to the principles of the disclosure. In this embodiment, the system can be configured similar to the embodiments depicted in FIG. 1A or 1B, except that the processor 10 includes an optional RAS location 36 connected to the return line. As seen in FIG. 3, the processor 10 can include a bioreactor and/or an internal biological selector comprising a plurality of biological selection zones, including any combination of one or more of, for example, an aerobic zone, an anaerobic zone, and an anoxic zone. The solid-liquid separator 20 can include a clarifier as with all activated sludge processes. A MBR (membrane bioreactor) can be associated with the processor 10 as an option for a solid liquid separator 20. The physical sequestrator 30 can include any combination of one or more gravimetric sequestrators and/or one or more screen sequestrators. In various embodiments the gravimetric sequestrator can include, for example, a hydrocyclone, a cyclone, a centrifuge, a high-rate clarifier, a settling column, a lamella, or a part of a reactor or clarifier that can be divided into stratification zones or fast and slow settling zones (for example, the clarifier shown in FIG. 5). The apparatus can include a mineral source (not shown) that supplies the addifeed 2 and/or an optional pre-sequestrator 11 that can receive CO₂ from any source, including the processor 10, for pre-acidification. The physical sequestrator 30 can be optional if a pre-sequestrator (for example, 11 shown in FIG. 11) is included and vice versa.

Still referring to FIG. 3, for MBR processes the solid-liquid separator 20 can include one or more membranes (not shown). In such applications the physical sequestrator 30 can operate to select solids/particles having predetermined characteristics and CaCO₃ to reduce fouling of the membrane(s), while providing added benefits related to flux, transmembrame pressure and permeability.

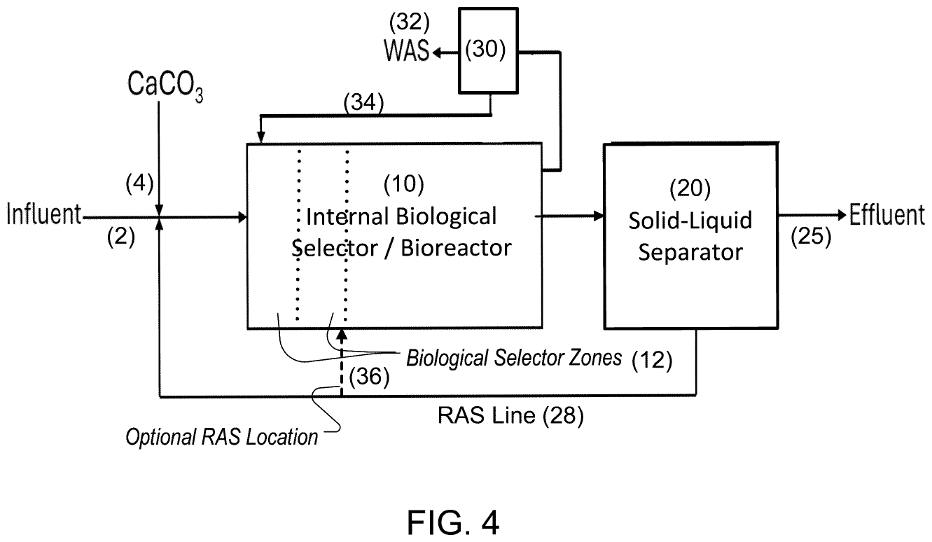

FIG. 4 shows a further nonlimiting embodiment of the activated sludge system according to the principles of the disclosure. In this embodiment, the system can be configured similar to the embodiment depicted in FIG. 2, except that processor 10 includes an optional RAS location 36 connected to the return line. As seen in FIG. 4, the processor 10 can include a bioreactor and/or an internal biological selector comprising a plurality of biological selection zones 12, including any combination of one or more of, for example, an aerobic zone, an anaerobic zone, and an anoxic zone. The physical sequestrator 30 can be configured to: receive at an input a solid-liquid mixture from the processor 10; select solids having predetermined characteristics (including CaCO₃); output the selected solids/particles at a first output 34 to an upstream location in the processor 10; and, output the remainder to the waste streamline (WAS) 32. The apparatus can include a mineral source (not shown) that supplies the addifeed 4 and an optional pre-sequestrator 11 (as described in FIG. 11, FIG. 12A, FIG. 12B) that can receive CO₂ from any source, including the processor 10, for pre-acidification. The physical sequestrator 30 can be optional if a pre-sequestrator (for example, 11 shown in FIG. 11) is included and vice versa.

Still referring to FIG. 4, for MBR processes the solid-liquid separator 20 can include one or more membranes (not shown). In such applications the physical sequestrator 30 can operate to select solids/particles having predetermined characteristics and CaCO₃ to reduce or eliminate fouling of the membrane(s), while providing added benefits related to flux, temperature, and permeability.

FIG. 5 shows a further nonlimiting embodiment of the activated sludge system according to the principles of the disclosure. In various embodiments, including this embodiment, the processor 10 can include an internal physical sequestrator 18 (or 27) and a processor 10 (reactor or bioreactor) configured with one or more of internal biological sequestration zones 12, including at least one of an internal sequestrator zone 18 and/or a stratification zone 18; and the solid-liquid separator 20 can include a clarifier and an internal sequestration baffle 27.

In some embodiments, the internal physical sequestrator 18/27 can include any one or more of a lamella, a baffle, or a mixing source, a flow source, a gas source, a differential source, or stratification conditions, to classify and select particles/solids in the processor 10. The internal physical sequestrator 18 can be configured to produce solids differentials according to the processes described herein, including through approaches that include but are not limited to quiescence or low or intermittent mixing conditions. The stratification zone can be anywhere in the bioreactor/processor 10 or solid liquid separator 20.

In various embodiments, the flow source (not shown) can include a pump and a pump outlet positioned at or near the bottom of the processor 10 for recycling sludge and undissolved CaCO₃, or a surface wasting pump (not shown) having an outlet positioned to waste the surface solids devoid of CaCO₃. Internal sequestration by the internal biological sequestration zones 12 and/or the internal physical sequestrator 18 increases the solids residence time or dissolution of alkaline minerals, such as, for example, by shear, mixing, settlement, dead zones, stratification (within reactor zones 12), baffles, walls, recycling of settled or stratified materials, covers, and/or head/pressure. Internal sequestration can also include temperature control to create and maintain temperature differentials (for example, through heat addition) and/or creating micro or macro zones in the bioreactor for such mineral dissolution or carbon dioxide sequestration.

In various embodiments, the internal physical sequestrator 18/27, the solid-liquid separator 20, and/or the physical sequestrator 30 can have a rectangular clarifier design, a circular clarifier design, or any other suitable design for sequestrating solids/particles having predetermined characteristics from other solids/particles and/or liquids. Stratification can be induced. The solid-liquid separator 20 can include one or mor baffles 27. Feed can be introduced in various ways to separate faster from slower settling biomass, including particles/solids. In some embodiments, including the embodiment depicted in FIG. 5, faster settling solids accumulate in the upstream zone (for example, to the left of the baffle 27), whereas the remainder accumulate in the downstream zone (for example, to the right of the baffle 27). The accumulated solids in both the faster settling zone and slower settling zone can be returned to the input of the processor 10 and a portion of the slower settling zone can be output to the waste stream (WAS). The effluent can be output as effluent 25. The solid-liquid separator 20 can also be a membrane bioreactor.

In some embodiments, including the embodiment of FIG. 5, the apparatus can include a classifier (not shown) and an internal physical sequestrator (for example, 18) located between the processor 10 and the classifier (not shown). The classifier can include any form of classifier including and not limited to a mechanical classifier such as used for grit, or a lamella or a sedimentation basin. The apparatus can include multiple internal physical sequestrators. The internal sequestration could be through ballast assisted classification as variously described associated with FIG. 1A.

In some embodiments, including the embodiment of FIG. 5, the apparatus can include a mineral source (not shown) that supplies the addifeed 4 and an optional pre-sequestrator (for example, 11 shown in FIG. 11, FIG. 12A, FIG. 12B) that can receive CO₂ from any source, including the processor 10 for pre-acidification. The internal physical sequestrator 18/27 can be optional if a pre-sequestrator is included, and vice versa.

FIG. 6 shows a further embodiment of the activated sludge system, according to the principles of the disclosure. In some embodiments, including the embodiment depicted in FIG. 6, the system can be configured similar to the embodiments depicted in FIG. 5, except that the system includes an external physical sequestrator 30 that has an input connected to the slower settling zone of the solid-liquid separator 20. Any form of internal physical sequestration 18,27 can be combined with a form of external physical sequestration 30. The physical sequestrator 30, which can include one or more gravimetric sequestrators and/or one or more screen sequestrators or other forms of aforementioned physical sequestration, is configured to select solids/particles having predetermined characteristics and return the selected solids/particles to the return line. The remainder is output from the physical sequestrator 30 to the waste stream (WAS).

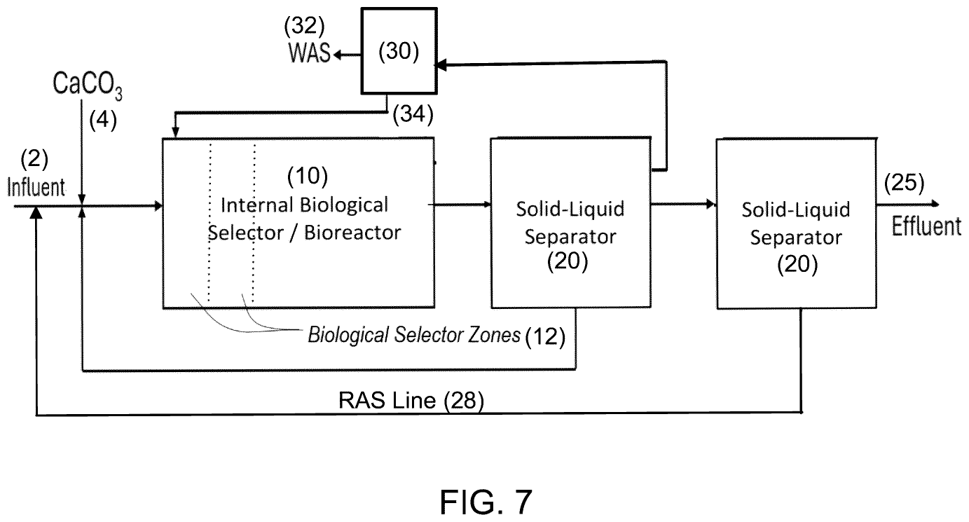

FIG. 7 shows a further embodiment of the activated sludge system according to the principles of the disclosure. In some embodiments, including this embodiment, the system includes a plurality of solid-liquid separators 20 connected in series or cascade, including a first solid-liquid separator 20 connected to an output of the processor 10 and a second solid-liquid separator 20 connected to an output of the first solid-liquid separator 20. In various embodiments the first solid-liquid separator 20 can include, for example, a high-rate clarifier or lamella having one output connected to the return line and another output connected to an input of an optional physical sequestrator 30, as seen in FIG. 7. The first solid-liquid separator 20 can be configured to select solids/particles having predetermined characteristics from the rest of the solid-liquid mixture output from the processor 10 and output the selected solids to the return line, with the remainder being output to the optional physical sequestrator 30 and the second solid-liquid separator 20. The second solid-liquid separator 20 can be configured to select any remaining solids/particles and return the selected solids/particles to the input of the processor. The first and second solid-liquid separators 20 can have the same or different structures or designs. The wasting can occur out of either solid-liquid separator depending on whether the separator is used as an internal sequestrator or in conjunction with an external physical sequestrator 30.

In various embodiments, including the embodiments of FIGS. 1A-12, addifeed such as calcium carbonate (CaCO₃) or other mineral carbonate can be contained and/or retained in the core of the floc, similar to, for example, as discussed above with references to FIGS. 1A, 1B, and 2.

FIG. 8 shows a nonlimiting process 100 for treating water or wastewater containing solids/particles while simultaneously generating alkalinity and reducing or eliminating addifeed, including CaCO₃, that might end up in waste solids. The process 100 provides increased Ca²⁺ concentrations (and Mg²⁺) relative to Na⁺ and K⁺ compared to state-of-the-art wastewater treatment technologies. The process 100 can use lower quality addifeeds such as CaCO₃ contaminated with Mg solids including MgO for the CaCO₃ added to the influent 2. The process 100 can be carried out by the controller 50 (shown in FIG. 1B) by running one or more computer programs comprising computer-readable instructions or code that, when executed by the one or more computers or microprocessors in the controller 50, cause the system to carry each of the steps 110 to 190.

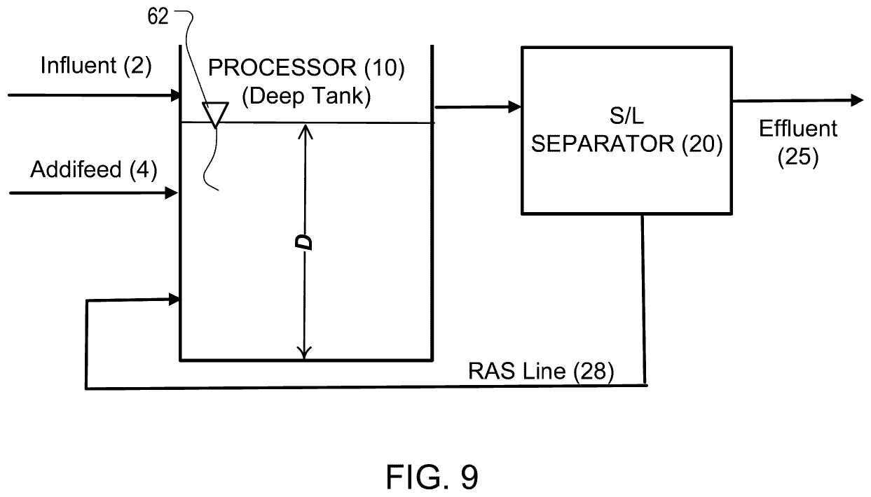

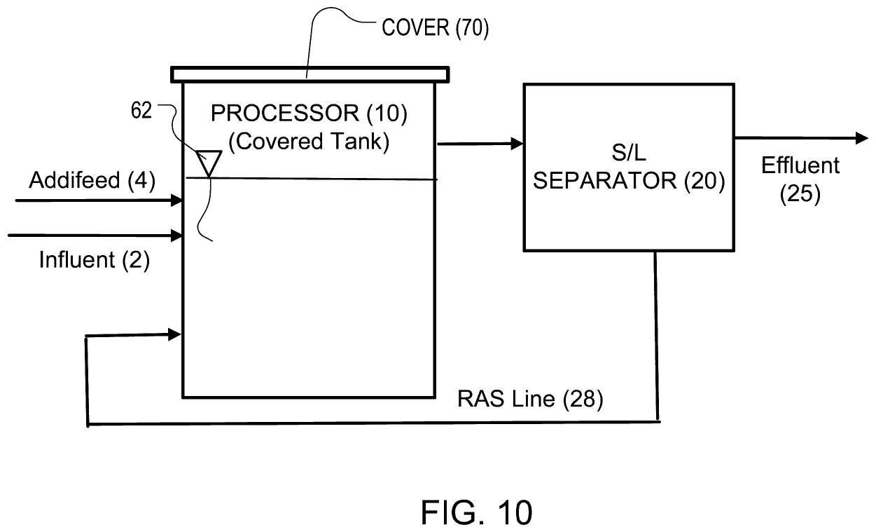

FIGS. 9 and 10 show further embodiments of the activated sludge system according to the principles of the disclosure. In some embodiments, including the embodiments depicted in FIGS. 9 and 10, the system includes a processor 10 having one or more deep tanks or covered tanks configured to receive and process addifeed 4, including expressly for carbon sequestration and to maintain a sufficient alkalinity in the effluent representing such sequestration. The deep tank has a depth D, which can be in the range of, for example, 25 to 35 feet; and the covered tank has a cover 70, which can be configured to open and close under control of a controller (such as, for example, controller 50, shown in FIG. 1B). These deep and covered tanks are special cases of being internal sequestrators 18 to improve the dissolution of addifeed 4 and (or through) the concomitant dissolution of carbon dioxide. In such deep and covered tanks, the amount of addifeed 4 needed to bring the alkalinity to any value between 0 and 50 mg/L as CaCO3 or in cases of excess alkalinity addition to any value between 0 and 250 mg/L as CaCO3 is considered a measure needed to engender or improve nitrification rates and simultaneously sequester carbon dioxide.

The purposeful covering of tanks is envisioned, as shown, for example, in FIG. 10. The system can include a vacuum degassing unit 62 for the management of gases (such as CO₂ and N₂), as seen in the embodiments of FIGS. 9 and 10. The management of nitrification or any reactions can be addressed through the provision of sufficient inorganic carbon or through the management of inhibition and rates. Compared to state-of-the-art treatment systems and processes, the system provides significantly improved solids processing.

FIG. 11 shows another embodiment of the activated sludge system according to the principles of the disclosure. In some embodiments, including the embodiment in FIG. 11, the addifeed 4 (for example, CaCO₃) can be introduced as a dry, semi solid, or slurry (collectively in the embodiment called slurry) and the slurry can be preacidified in a pre-sequestrator 11 using a CO₂ flux from the processor 10 (for example, from the biological reactor) or any other CO₂ sequestration source (a pre-sequestrator). In some embodiments, including the embodiment of FIG. 11, the system can include, for example, a covered air tank or source, a purified air tank or source, or a pure oxygen tank or source, and the pre-sequestrator 11 can include a vent that is configured to output CO₂, which can then be introduced to the processor 10 and/or, in certain embodiments, an additional pre-sequestrator, a mineral tank, or a CaCO₃ slurry tank, any of which can be placed anywhere in the stream (upstream, midstream or downstream of a processor 10 (including the biological reactor).

In some embodiments, including the embodiment of FIG. 11, the headspace of the pre-sequestrator 11, such as, for example, the headspace of the CaCO₃ slurry tank, and a vented opening of the processor 10 (including bioreactor) are connected (directly or indirectly) by a vent 16 to support CO₂ dissolution in the slurry tank 11 while maximizing oxygen dissolution in the processer 10. The vent 16 can include, for example, one or more pipes, conduits, channels, or other structures that allow for passive (or active) exchange of gases between presequestrator 11 and processor 10. Since pure oxygen is expensive, the system can be configured for maximal effective use of the gas to dissolve the addifeed. In the system, the preacidification of slurry using CO₂ optimizes and/or reduces particle size through such pre-acidification and makes the slurry more amenable for downstream dissolution kinetics while sequestering or pre-sequestering the CO₂.

In some embodiments, including the embodiment of FIG. 11, the system includes a supply of air, purified air, or pure oxygen, such as, for example, from an oxygen purification device (not shown) or from electrolysis. The system is configured to supply and apply the air/oxygen directly or indirectly to various parts of the system, including, for example, the processor 10, presequestrator 11, solid-liquid separator 20, and/or RAS line 28, to: 1) improve physical or chemical dissolution of carbon dioxide from the biological consumption of such pure oxygen; 2) the preemptive, concomitant or subsequent addition of minerals; 3) improve physical, chemical, or biological dissolution; and 4) purposefully sequester carbon and/or prevent the formation of other greenhouse gases (for example, nitrous oxide or methane).

The headspace of the processor 10 can be directly or indirectly (including and not limited to a venturi, absorber, adsorber or a membrane separator) connected via the vent 16 to the head space of the presequestrator 11, for example, as seen in FIG. 11. In FIG. 11, the presequestrator 11 comprises the CaCO₃ slurry tank with its headspace connected, via the vent 16, to the upstream headspace of the processor 10 (and bioreactor) for the pre-dissolution of headspace or vented CO₂. This CO₂ gas, if needed, can be indirectly and preferentially selected by chemical absorption, physical adsorption or membrane separation in lieu of the vent. The reduction in CO₂ partial pressure (through this pre-dissolution) alleviates the depression of pH, for example in an aeration tank of the bioreactor, and can produce a draw condition, including, for example, diffusion, osmosis, or active delivery of the gas.

FIG. 12B shows an embodiment of the system which includes a processor 10 and a pre-sequestrator 11 that receives addifeed 4 and carbon dioxide from any source (internal or external) including a blower, mixer, generator, pump or another reactor. The addition of CO₂ improves the dissolution of addifeed 4. The system/process in FIG. 12A includes the processor 10, solid-liquid separator 20 and the pre-sequestrator 11, which receives addifeed 4 and carbon dioxide from a source (not shown), which can include an internal or external source of carbon dioxide, including, for example, a blower, mixer, generator, pump, or a bioreactor. The addition of CO₂ improves the dissolution of addifeed 4. In this approach, the pre-sequestrator 11 is configured as both a physical and a chemical sequestrator for selectively improving the dissolution of the addifeed using carbon dioxide that serves to acidify the slurry (such as by first forming carbonic acid and to then form a bicarbonate ion) and improves its dissolution while simultaneously performing sequestration. The improved dissolution of addifeed improves the provision of inorganic carbon or alkalinity to a processor, and/or improves rates or reaction stoichiometry in the processor, and/or improves solids properties. In the system, the pre-acidification of slurry using CO₂ optimizes and/or reduces particle size through such pre-acidification and makes the slurry more amenable for downstream dissolution kinetics while sequestering or pre-sequestering the CO₂. A benefit of such pre-acidification or pre-sequestrator 11 or a physical sequestrator 30, is the ability to use coarser grain size addifeed 4, that is less expensive, and/or easier to manufacture or process.

In various embodiments, the system/process of FIG. 12B can be included in (or in some embodiments, include) chemostats such as, for example, aquaculture and anaerobic digesters. In one embodiment, the carbon dioxide produced from anaerobic digestion (as an example) is partly or wholly dissolved in a pre-sequestrator 11 or such sequestrator placed in the gas-phase of the digester (as an example) for purification or partial purification (such as removal of CO₂ and H₂S) of such gas. The use of the pre-sequestrator 11 can considerably improve stability of digesters and reduce the needed solids residence time in such digesters to 15 days or even less. The use of one or more pre-sequestrators 11 can also facilitate the production and removal of crystals (including and not limited to struvite, brushite and hydroxyapatite). These pre-sequestrators 11 can be combined with one or more physical sequestrators 30 (including for example a screen or hydrocyclone or centrifuge or any other suitable device) in series or parallel for such mineral management. The phosphate precipitate is a sequestrated output or discharge stream of such mineral management.

In some embodiments, the system can optionally include any one or more of a physical, chemical, or biological sequestrator to improve mineral and/or carbon dioxide dissolution in the processor 10 (for example, in the bioreactor) and/or the pre-sequestrator 11 (for example, slurry tank). The system can include an optional internal (or external) physical sequestrator, such as, for example one or more gravimetric sequestrators and/or screen sequestrators. Low pH in high purity oxygen plants very often inhibits nitrification, even with sufficient solids residence time. The system's addition of CaCO₃ slurry to these processes, with or without physical sequestration included, allows for sufficient pH and alkalinity to allow for nitrification to occur unimpeded.

In one embodiment the use of oxygen sourced from electrolysis for production of pure oxygen is linked (as a system or method) to the improved physical or chemical dissolution of carbon dioxide through the use of covers, from the biological consumption of such pure oxygen, and/or thereafter the preemptive, concomitant or subsequent addition of minerals, resulting in improvements to its physical, chemical or biological dissolution, and to thereby sequester carbon or prevent the formation of other greenhouse gases (carbon dioxide, nitrous oxide or methane). A physical, chemical or biological sequestrator for improvements to mineral and/or carbon dioxide dissolution is an optional part of this embodiment.

In various embodiments, including the embodiments of FIGS. 1A-7 and 9-12B, the CO₂ associated with CaCO₃ slurry can be obtained from any concentrated source in a wastewater treatment plant and used for the pre-acidification reaction, or the slurry can be added anywhere within the process stream for the pre-acidification reaction. The approach improves the dissolution kinetics of CO₂ while adequately managing its sequestration. These sources include a digester gas purification (such as to methane) system (or integrated with the slurry tank), an engine, a motor, a generator, or any device or reactor that produces such CO₂.

In some applications associated with any of the above described systems/processes, the amount of alkalinity, expressed as CaCO₃ in the effluent 25 can range from 0 to 250 mg/L as CaCO₃. It is broadly understood that about 50 mg/L as CaCO₃ in the effluent (and thus in the reactor) may be needed for improved nitrification in processor 10. In the embodiments in which the processors 10 include covered tanks or deep tanks with injection/addition of oxygen, a sequestrator 18, or a pre-sequestrator 11 in conjunction with an addifeed 4, can be included to achieve an alkalinity between 0 and 50 mg/L, or in some instances that exceeds 50 mg/L, which is more than typically prescribed for nitrification, but nevertheless can improv rates of dissolution, solids properties such as settleability, as well as carbon sequestration. In some embodiments, the system/process can achieve alkalinity in excess of 50 mg/L as CaCO₃ can be considered a measure of alkalinity over and beyond the minimum needed, and yet quite beneficial, and an approach to differentiate typical alkalinity needs and provisions and the opportunity addressed by pre-sequestration (for example, by a pre-sequestrator 11) or physical sequestration (for example, by a physical sequestrator 30) of solid addifeed 4 or sequestration of gaseous carbon dioxide. The concentration of effluent alkalinity greater than 50 mg/L as CaCO₃ in many applications can be indirectly or directly linked to the ‘excess alkalinity’ associated with addifeed 4, physical sequestration 30/18/27 or pre-sequestration 11 and used as a measure of the inventions use of addifeed and the resulting improved dissolution. A presequestrator 11 has the function of a sequestrator 30, except that it is placed ahead of the processor 10, and essentially manages the dissolution of minerals or addifeed either physically or chemically.

While the process 100 can be carried out (for example, by the controller 50, shown in FIG. 1B) by any of the various embodiments of the system, including those shown in FIGS. 1A-7 and 9-12B, the process is described with reference to FIGS. 1B and 8 with an understanding that the description can apply equally to any of the other embodiments, including those in FIGS. 1A-7 and 9-12B.

Referring to FIGS. 1B and 8 together, the process 100 can begin by receiving an influent 2 (at step 110) and adding CaCO₃ 4 (at step 120). The influent 2 with CaCO₃ 4 is supplied to the processor 10 (at step 130) and mixed with the solid/liquid mixture in the processor 10 (at step 140). The solid/liquid mixture is treated in the processor 10 by, for example, a biological process (at step 150). In some embodiments, the solid-liquid mixture in the processor 10 can be subjected to particle classification and/or sequestrations by any one or more internal biological selectors and/or internal physical sequestrators, as described above.

A biomass containing solids/particles can be output from the processor 10 to an input of the physical sequestrator 30 via the solid-liquid separator 20 (for example, as seen in FIGS. 1A, 1B) or directly (for example, as seen in FIGS. 2, 4) (at step 160), where solids/particles having predetermined characteristics are selected from other solids or a solid-liquid mixture. In various embodiments, including the embodiments of FIG. 1 and FIG. 2, the effluent 25 is output at one output of the solid-liquid separator 20 to an effluent supply line. However, in some embodiments, including the embodiments of FIGS. 1A and 1B, solids/particles are output at another output of the solid-liquid separator 20 to either or both the input of the processor 10 (for example, shown in FIG. 2) and/or an input of the physical sequestrator 30 (for example, shown in FIGS. 1A, 1B).

Depending on whether the physical sequestrator 30 is configured according to, for example, the embodiments depicted in FIGS. 1A, 1B, or the embodiment depicted in FIG. 2, at step 170 the physical sequestrator 30 receives either the solids/particles from an output of the processor 10 (FIG. 2) or the output of the solid-liquid separator 20 (FIGS. 1A, 1B) and selects and retains predetermined solids/particles for further granulation or granule formation and undissolved CaCO₃ for further dissolution. The retained solids/particles with undissolved CaCO₃ are output from the physical sequestrator 30 and supplied to an input of the processor 10, which may be located upstream (for example, shown in FIGS. 1A, 1B) or at a location downstream of the influent 2 supply point (for example, shown in FIG. 2). Unless the process is terminated (YES at step 190), the process will continue (NO at step 190) and repeat steps 110 to 190 and continue creating favorable conditions for the microorganisms responsible for the treatment process and enhancing their activity to treat newly added influent while reducing CO₂ stripping and improving nitrification and biological phosphorus, maintaining increased levels of alkalinity and pH, reducing or eliminating levels of CaCO₃ output from the process, and consequently decreasing greenhouse gas emissions from the process.

Referring to FIGS. 1B and 8, in various embodiments, the process 100 can include receiving measurement signals from the one or more sensors 40 via the sensor lines 6, processing the measurement signals to determine the real-time or near real-time conditions and operation of each part of the system and treatment process therein, and, by the controller 50, carrying out each of the steps 110 to 190 based on the measurement data and assessed real-time or near real-time conditions and operations to operate as described herein, with respect to the various embodiments, including the embodiments of FIGS. 1-11.

The terms “a,” “an,” and “the,” as used in this disclosure, means “one or more,” unless expressly specified otherwise.

The term “addifeed,” as used in this disclosure means a dissolvable mineral that is a solid form, a liquid form, a gaseous form, or any combination thereof, and that includes any one or more of dissolvable calcium carbonate (CaCO₃), mineral carbonate, mineral hydroxide, mineral oxide, mineral containing alkalinity, calcium oxide (CaO), calcium hydroxide (Ca(OH)₂), magnesium (Mg) solids, magnesium oxide (MgO), magnesium hydroxide (Mg(OH)₂), barium hydroxide (Ba(OH)₂), magnesium hydroxide (Mg(OH)₂), aluminum hydroxides (Al(OH)₃ or AlO(OH)), iron oxyhydroxide (FeO(OH)), manganese oxyhydroxide (MnO(OH)), calcium magnesium carbonate (CaMg(CO₃)₂), magnesium carbonate (MgCO₃), iron carbonate (FeCO₃), manganese carbonate (MnCO₃), zinc carbonate (ZnCO₃), orthorhombic form of CaCO₃, strontium carbonate (SrCO₃), barium carbonate (BaCO₃), copper carbonate Cu3(4)(CO3)2(OH)2, or any equivalent of any of the foregoing. It is noted that in some embodiments any reference to addifeed (or CaCO₃) in this disclosure also refers to any mineral carbonates or other anionic substances (for example, supported by any cation including, alkaline minerals, alkaline earth minerals, calcium, magnesium, iron, aluminum, or combinations thereof that are natural minerals or artificial minerals) that are either particulate or colloidal in nature. It is also noted that in some embodiments the reference to addifeed or CaCO₃ in this disclosure also includes the use of metal oxides or metal hydroxides or any natural or synthetic mineral material that enhances alkalinity in particulate or colloidal form, which on dissolution generate alkalinity and decrease the emission of carbon dioxide.

The Solid-Liquid Separator is optional when the bioreactor or culturing reactor is operated as a chemostat. Examples include a digester or an aquaculture tank.

In various embodiments, there are multiple flows (such as, for example, the influent, addifeed, RAS, and/or sequestrated addifeed) entering the processor (10). These flows can be: merged into one; kept separate; enter the processor together in parts or as a whole; introduced at any location of the processor. In some embodiments, influent is received from multiple influent sources, each influent of which can be individually or jointly cascaded, enter into the processor in series, parallel, as tributaries or as distributaries. Any flow can be merged before entering the processor 10, such as, for example, in a holding tank or other containment device that may contain a mixer or a pump as needed or understood by those skilled in the art. A flow can be stopped or not installed if considered unnecessary or redundant.

In various embodiments, there are multiple flows (such as effluent and WAS) leaving the processor 10 or sequestrator 20/30. These flows can be merged into one, kept separate, enter the processor 10 together in parts or as a whole, at any location of the processor 10. These effluents can individually or jointly be cascaded, leave the processor 10 in series, parallel, as tributaries or as distributaries. Any flow can be merged before leaving the processor/sequestrator in a holding tank that may contain a mixer or a pump as needed or understood by those skilled in the art. A flow can be stopped or not installed if considered unnecessary or redundant.

In an embodiment, the system/process includes either or both a sequestrator 20/30 or pre-sequestrator 11 to improve the dissolution of minerals, either physically or chemically, and thereby to also improve the dissolution of gas-phase carbon dioxide to form an acid and/or to form bicarbonate ion. In this embodiment, sequestration includes either or both a physical or chemical sequestrator that achieves a solid-phase sequestration of minerals to further accommodate gas-phase sequestration of carbon dioxide. The solid-phase sequestration of minerals improves liquid-phase dissolution of minerals for the gas-phase sequestration and dissolution of carbon dioxide. A limitation associated with this supply of minerals (including, and not limited to, calcium carbonate) can be the management of this solid-phase and gas-phase dissolution. In this embodiment, the system/process is configured to control and manage this dissolution and/or the relative proportions of dissolved and particulate minerals, while simultaneously managing and controlling rates (for example, flow rate, dissolution rate, rate of change in wastage ratio, biological selection rate, phosphorous removal rate, and other rates that affect treatment, culturing, processing and resultant byproducts) or solids properties (for example, settling rate, density, particle size, compressibility, and other properties of solids that affect treatment processing and resultant byproducts) using the sequestrator 20/30 or pre-sequestrator 11.

In the instant disclosure, physical sequestrators (such as, for example, 18, 20, 27, 30) can include any device, component, or mechanism designed and/or constructed (including, electrical, mechanical, or hydraulic) to achieve sequestration by physical operating on an organism, solid, liquid, and/or gas to isolate, capture, or store something (for example, solids, liquids, and/or gases that include or affect carbon, carbon dioxide, or greenhouse gases) to prevent its release or interaction, or to utilize that something elsewhere. Chemical sequestrators (such as, for example, used in the processor 10) can include any chemical that achieves sequestration by chemically operating on an organism, solid, liquid, and/or gas to isolate, capture, or store something (for example, solids, liquids, and/or gases that include or affect carbon, carbon dioxide, or greenhouse gases) to prevent its release or interaction, or to utilize that something elsewhere. In various embodiments, chemical sequestrators include carbon dioxide such as in a pre-sequestrator 11, internal sequestrator (for example, in a bioreactor in the processor 10), or in an external device containing the chemical sequestrator. Various embodiments include chemical sequestration interchangeably or together with physical sequestration. A chemical sequestrator can also include the off-gassing of carbon dioxide for purposeful production and thereafter removal of minerals (such as struvite, brushite or hydroxyapatite). The various means of use of carbon dioxide described in this specification are means for achieving chemical sequestration.

The various embodiments or drawings include one or more of a pre-sequestrator, an internal sequestrator, an external sequestrator, a physical sequestrator, a chemical sequestrator or a biological sequestrator. These sequestrators could function separately, together, or as one, with an associated processor. The sequestrators perform sequestration. These sequestrators or sequestration in addition to other objectives, serve to improve the dissolution of the addifeed as a function, method or apparatus. The dissolution of addifeed improves the stoichiometry or rates of organisms or substances, and/or the sequestration of carbon dioxide. The improvement of stoichiometry or rates can be from the protonation or deprotonation of a substrate or inhibitor that occurs as a result of a change in pH. The improvement of stoichiometry or rates can be from the change in ionization (ionized or unionized form) of a substrate or inhibitor that occurs as a result of a change in pH. The improvement of stoichiometry or rates can be from the provision of inorganic carbon such as for autotrophic or hydrogenotrophic reactions. The improvement of stoichiometry or rates can be from charge balancing (such as of polyphosphates), charge bridging, solids residence time uncoupling, or from any aspect beneficial from the provision of addifeed.

The terms “first,” “second,” “third,” or the like, as used in this disclosure, do not necessarily connote any sequence or order, but rather can serve to refer to separate components, articles, or devices.

The terms “including,” “comprising,” “having,” “containing,” and variations thereof, as used in this disclosure, mean “including, but not limited to,” unless expressly specified otherwise.

Although process steps or method steps may be described in a sequential order, such processes and methods can be configured to work in alternate orders. In other words, any sequence or order of steps that may be described does not necessarily indicate a requirement that the steps be performed in that order. The steps of the processes or methods described herein can be performed in any order practical. Further, some steps can be performed simultaneously.

When a single structure, device, or article is described herein, it will be readily apparent that more than one structure, device, or article may be used in place of the single structure, device, or article. Similarly, where more than one structure, device, or article is described herein, it will be readily apparent that a single structure, device, or article may be used in place of the more than one structure, device, or article. The functionality or the features of a structure, device, or article may be alternatively embodied by one or more other structures, devices, or articles that are not explicitly described as having such functionality or feature.

While the disclosure has been described in terms of exemplary embodiments, those skilled in the art will recognize that the disclosure can be practiced with modifications in the spirit and scope of the instant disclosure. These examples given above are merely illustrative and are not meant to be an exhaustive list of all possible designs, embodiments, applications or modifications of the disclosure.

Devices that are in contact with each other need not be in continuous contact with each other unless expressly specified otherwise. In addition, devices that are in contact with each other may contact directly or indirectly through one or more intermediaries.

What is claimed is:

1. An apparatus for culturing or treating water or wastewater, the apparatus comprising:
an influent input that is configured to receive an influent from a first source;
an additive input configured to receive an addifeed from a second source;
a processor configured to receive and supply the influent and the addifeed to a treatment or culturing process in a bioreactor, the processor being further configured to output a solid-liquid mixture containing a biomass that includes solids and solids with undissolved addifeed; and
a sequestrator or pre-sequestrator configured to
sequestrate the solids with undissolved addifeed,
output non-sequestrated solids at a first output as a waste stream, and
output the solids with undissolved addifeed as a recycle stream at a second output,
wherein the recycle stream is returned to the processor and added to the culturing or treatment process in the bioreactor to promote the dissolution of the returned addifeed for the sequestrating of carbon dioxide.

2. The apparatus in claim 1, further comprising:
a solid-liquid separator having an input and at least two outputs,
wherein the solid-liquid separator is configured to
receive, from the processor, the solid-liquid mixture,
separate from the solid-liquid mixture the biomass that includes the solids and the solids with undissolved addifeed,
output a treated effluent at one of the at least two outputs, and
output the biomass that includes the solids and the solids with undissolved addifeed at another of the at least two outputs.

3. The apparatus in claim 2, wherein said another of the at least two outputs of the solid-liquid separator is connected to the input of the physical sequestrator.

4. The apparatus in claim 2, wherein:
the solid-liquid separator includes one or more of a settling tank, a lamella clarifier, a filter, a dissolved air floatation or a membrane; and
the physical sequestrator comprises
one or more of a density, size, shear or compressibility sequestrator, or
one or more of a cyclone, a screen, a filter, a centrifuge, a lamella clarifier, or a settling column.

5. The apparatus in claim 2, wherein the solid-liquid separator comprises an underflow output.

6. The apparatus in claim 1, wherein a wastage ratio of addifeed in the apparatus is between 0 percent and 50 percent.

7. The apparatus in claim 1, further comprising:
a return line connected to the processor,
wherein
the second output of the physical sequestrator is wholly or partly connected to the return line, and
the return line supplies the recycle stream to the processor.

8. The apparatus in claim 1, wherein the physical sequestrator is connected by at least one conduit to the processor and the recycle stream contains a majority of the solids with undissolved addifeed.

9. The apparatus in claim 1, wherein the additive input is located upstream of the processor.

10. The apparatus in claim 1, wherein the additive input is connected to the recycle stream or to a sludge line upstream of the recycle stream.

11. The apparatus in claim 1, wherein the physical sequestrator is configured to provide, or increase, dissolution time for undissolved addifeed to dissolve and reduce a wastage ratio of addifeed in the apparatus.

12. The apparatus in claim 1, wherein the physical sequestrator is configured to retain the solids with undissolved addifeed to provide continuous or enhanced dissolution of undissolved addifeed.

13. The apparatus in claim 1, wherein the physical sequestrator is configured to:
retain the solids with undissolved addifeed and minimize loss to a waste activated sludge line;
maintain an wastage ratio of addifeed in a range between 0 percent and 50 percent;
adjust a rate or an amount of dissolution of undissolved addifeed when the wastage ratio of addifeed is more than 5 percent; and/or
adjust the wastage ratio of addifeed by more than 5 percent.

14. The apparatus in claim 1, wherein the apparatus is configured to receive an amount of the addifeed at the additive input that increases alkalinity in the treatment or culturing process up to a maximum alkalinity level where carbon dioxide (CO₂) volatilization is driven to less than 1% of predetermined baseline CO₂ emissions.

15. The apparatus in claim 1, wherein the apparatus is configured to receive an amount of the addifeed at the additive input that increases alkalinity in the treatment or culturing process up to a maximum alkalinity level where a pH level of the biomass in either (i) the treatment or culturing process or (ii) the treated effluent reaches an upper pH limit threshold, thereby reducing carbon dioxide (CO₂) stripping during the treatment or culturing process, wherein the upper pH limit threshold is less 9.0.

16. The apparatus in claim 2, wherein:
the apparatus is configured to receive an amount of the addifeed at the additive input to act as a ballast or a stratum for biofilm in the processor;
the treatment or culturing process includes an activated sludge process or an aquaculture process; and
the solid-liquid separator comprises at least one of a clarifier, a filter, a dissolved air floatation unit, or a membrane separator.

17. The apparatus in claim 1, wherein:
the processor includes an internal solid-liquid separator;
the internal solid-liquid separator includes a membrane bioreactor; and
an amount of addifeed received at the additive input decreases CO₂ emissions of the treatment or culturing process by at least 10% compared to baseline CO₂ emissions without addifeed, reduces a rate of membrane fouling such that the membrane permeability is increased by at least 10% above baseline conditions.

18. The apparatus in claim 1, wherein the addifeed comprises dissolvable calcium carbonate (CaCO₃) to increase Ca²⁺ concentrations relative to concentrations of Na⁺ and/or K⁺ in the treatment or culturing process to support settling and/or removal of biological phosphorous (P) by the treatment or culturing process.

19. The apparatus in claim 1, wherein the addifeed comprises dissolvable calcium carbonate (CaCO₃) and magnesium (Mg) solids that increase Mg²⁺ concentrations relative to concentrations of Na⁺ and/or K⁺ in the treatment or culturing process to support settling and/or biological phosphorous (P) removal by the treatment or culturing process.

20. The apparatus in claim 1, wherein the addifeed comprises dissolvable calcium carbonate (CaCO₃) contaminated with magnesium (Mg) solids or lime (CaO or Ca(OH)2).
